(19) United States
(12) Patent Application Publication
(10) Pub. No.: US 2002/0059092 A1
(43) Pub. Date: May 16, 2002

(54) Behavior data fee collection system

(76) Inventors: Hirohisa Naito, Kawasaki (JP); Kuniharu Takayama, Kawasaki (JP); Minoru Sekiguchi, Kawasaki (JP); Yoshiharu Maeda, Kawasaki (JP)

Correspondence Address: STAAS & HALSEY LLP, 700 11TH STREET, NW, SUITE 500, WASHINGTON, DC, 20001, US

(21) Appl. No.: 09/802,998

(22) Filed: Mar. 12, 2001

(30) Foreign Application Priority Data
Sep. 8, 2000 (JP) 2000-273106

(51) Int. Cl. G06F 17/60

(52) U.S. Cl. 705/10

(57) ABSTRACT

By implementing a unit obtaining behavior data, a unit recording/storing the obtained behavior data and a unit calculating the fee of the recorded/stored behavior data and selling the behavior data by a computer system, the behavior data are traded. By using data in which a paired series of place information/time information and information provided to a user depending on a time/place to be presented are described according to a prescribed specification, the utility of such data can be improved. In this way, a system in which data about a series of human consecutive behavior can be collected and the behavior data can be sold, can be provided, and as a result, behavior data can be effectively utilized for commodity development, information service, advertisement/commercial, etc.

### BACKGROUND OF THE INVENTION

1. Field of the Invention

Recently a concept of CRM (Customer Relationship Management) has been popular and the number of companies advocating a customer-centered policy has increased. In that case, it is said that collectively providing related commodities and services instead of selling an individual commodity separately is useful for both users and sellers. By obtaining a customer on a line or plane instead of at a point, a sales strategy for the customer is made easy to plan and as a result, sales to the customer is made easy to make.

The present invention relates to both a technology for obtaining/generating the behavior data of a user and selling the behavior data and a technology for developing commodities and providing information services based on the behavior data. The present invention also relates to a system for trading mass marketing data. The present invention also relates to a system for collecting fees from facilities, etc., included in location information by using data in which a paired series of at least location information/time information and information to be provided to a user depending on both a place and a time to be presented are described according to a prescribed specification (hereinafter called a “behavior script”).

2. Description of the Related Art

The conventional marketing data are obtained by mainly collecting the following data related to a place or thing.

How many people gather where and when?

How many commodities sell when and where?There is conventionally a system for collecting and trading such marketing data. For example, a commodity purchased by a person belonging to the same category as that of a target person can be selected and recommended by obtaining the purchase histories of many purchasers and categorizing them based on information about the attribute of a purchaser, purchase time, etc.

However, the data are collected based on one point of commodity purchase, and there is no marketing data about a series of consecutive human behavior. Nor there is means for developing commodities, advertising them and providing information about them using the data.

As means for generating and executing a guidance script in which behavior can be described in a computer-recognizable format, for example, Japanese Patent Laid-open No. 2000-215211 “Navigation information Provision Device, Navigation Information Provision Processing Method, Storage Medium on which Navigation information Provision Program is recorded, Storage Medium of Navigation Script, Navigation Script Generation Device, Operation Management Device using Navigation Script, Method thereof and Storage Medium, Travel Time Adjustment Device using Navigation Script, Method thereof and Program Storage Medium, Navigation Plan Generation Device, Method thereof and Program Storage Medium, Navigation information Provision Device, Method thereof and Program Storage Medium” is already publicly known. However, this technology does not disclose a mechanism for collecting a fee from a facility when facility information is included in the guidance script.

Since a thing to be purchased or a place to go is not known although there is leisure or time, the thing to be purchased or the place to go is often determined referring to an information journal, etc. In such a case, the provision of information in relation to the attribute and taste of a customer instead of sending direct mail (DM) at random or the introduction/proposal of a total plan, including the purchase of related commodities instead of one commodity is more efficient for both a customer and a seller.

To efficiently implement such introduction/proposal, data about commodities liked by a person with a specific attribute and taste or data about other commodities liked by a person who likes a specific commodity A, etc., are required. Such data about commodities have already been collected to some amount by using the POS (Point Of Sales) in shops and the history information of credit cards.

The same applies to the introduction/proposal of places to go. The provision of information in relation to the attribute and taste of a customer and the introduction/proposal of a total plan for making a tour to several places instead of proposing one place is more efficient for both a customer and a seller. To efficiently implement data about such introduction/proposal, places visited by a person with a specific attribute and taste, data about other places liked by a person who often visits a specific place X, etc., are required.

However, there is conventionally no system for collecting and selling such data about a series of human behavior.

If a customer travels according to a specific behavior plan, facilities in places included in the behavior plan can provide the customer with more effective services by effectively using information obtained from the behavior plan. However, there is not currently a mechanism for providing such a service.

### SUMMARY OF THE INVENTION

It is an object of the present invention to provide a mechanism for collecting behavior data about behavior taken by each customer and selling the data in order to solve the problems described above. It is another object of the present invention to provide a mechanism for sales strategies based on the behavior data.

It is another object of the present invention to provide a system for reporting in advance the facility utilization plan of a customer to a facility by using behavior data, such as a behavior script, etc., with means for charging when behavior data are generated or used in order to solve the problems described above and to implement a system for establishing such a service as business.

The behavior data fee collection system of the present invention comprises a behavior data acquisition unit, a behavior data recording/storage unit, a data sale unit, amass behavior generation unit, a data process unit, a fee collection unit, a place data acquisition unit, a behavior data generation unit, a behavior data fee calculation unit, a facility data registration unit, a registration fee calculation unit, a behavior data process unit, a charging unit, a user situation acquisition unit, an information provision unit, a judgment unit, a travel data acquisition unit, a judgment unit, a facility data acquisition unit, an information provision/advertisement unit and a proposal unit.

In the first aspect of the present invention, the behavior data acquisition unit obtains behavior data about a series of human behavior. The behavior data recording/storage unit records/stores obtained behavior data. The data sale unit sells the recorded/stored behavior data.

In the second aspect of the present invention, the behavior data acquisition unit obtains behavior data about a series of human behavior. The behavior data recording/storage unit records/stores the individual obtained behavior data. The mass behavior data generation unit analyzes the recorded/stored behavior data and generates mass behavior data by statistically processing the behavior data. The data sale unit sells the generated mass behavior data.

In the third aspect of the present invention, the data process unit processes data in which a paired series of at least place information and information about the place provided to a user are described according to a prescribed specification. The fee collection unit collects fees from facilities included in the place information described in the data.

In the fourth aspect of the present invention, the data process unit processes data in which a paired series of at least place information and information about the place provided to a user are described according to a prescribed specification. The place data acquisition unit obtains place information transmitted from the place. The behavior data generation unit collects information obtained from the place data as behavior data. The behavior data fee calculation data calculates the fee of the behavior data.

In the fifth aspect of the present invention, the facility data registration unit registers the data of facilities. The registration fee calculation unit calculates the fee when the data is registered. The behavior data generation unit generates data in which a paired series of at least place information and information about the place provided to a user are described according to a prescribed specification using the registered facility data.

In the sixth aspect of the present invention, the facility data registration unit registers facility data. The behavior data generation unit generates data in which a paired series of at least place information and information about the place provided to a user are described according to a prescribed specification using the registered facility data. The behavior data process unit obtains information about the use of data when the data are generated. The charging unit charges a fee against each facility at the time.

In the seventh aspect of the present invention, the facility data registration unit registers facility data. The behavior data generation unit generates data in which a paired series of at least place information and information about the place provided to a user are described according to a prescribed specification using the registered facility data. The behavior data process unit obtains information about the use of data when the data are downloaded, when the use of the data is started, when each facility is reported in the process of the data or when guidance or advertisement on each facility is presented to a user in the process of the data. The charging unit charges a fee against each facility at the time.

In the eighth aspect of the present invention, the user situation acquisition unit obtains the location or route of a user. The information provision unit provides information based on the obtained location or route. The charging unit charges the fee when the information is provided.

In the ninth aspect of the present invention, the facility data registration unit registers facility data. The behavior data generation unit generates data in which a paired series of at least place information and information about the place provided to a user are described according to a prescribed specification using the registered facility data. The user situation acquisition unit obtains the location or route of a user. The judgment unit judges relationship between the actual location or route of a user and the data. The behavior data process unit obtains information about the use of data when the data are downloaded, when the use of the data is started, when each facility is reported in the process of the data. The charging unit charges a fee against each facility at the time.

In the tenth aspect of the present invention, the facility data registration unit registers facility data. The travel data acquisition unit obtains the travel data of a user. The judgment unit judges whether location data included in the facility data match the travel data of the user. The behavior data generation unit generates the behavior data of the user based on the judgment result. The behavior data fee calculation unit calculates the fee of the behavior data.

In the eleventh aspect of the present invention, the facility data registration unit registers facility data. The facility data acquisition unit obtains the utilization data of a user. The judgment unit judges whether the facility data match the utilization data of a user. The behavior data generation unit generates the behavior data of a user based on the judgment result. The behavior data fee calculation unit calculates the fee of the behavior data.

In the twelfth aspect of the present invention, the behavior data acquisition unit obtains behavior data about a series of human behavior. The information provision/advertisement unit detects a combination of a plurality of pieces of behavior frequently taken from the obtained behavior data, and when a user takes one of the combinations, the unit provides information about or advertises the same behavior combination.

In the thirteenth aspect of the present invention, the behavior data acquisition unit obtains behavior data about a series of human behavior. The proposal unit categorizes the obtained behavior data for each attribute of a user, and when the user with a specific attribute makes a request for the proposal of a destination, the unit proposes a destination matching the attribute.

### BRIEF DESCRIPTIONS OF THE DRAWINGS

FIG. 1 shows one configuration of the behavior data fee collection system (No. 1);

FIG. 2 is a flowchart showing the process of the behavior data acquisition unit;

FIG. 3 is a flowchart showing the process of the data sale unit;

FIG. 4 shows another configuration of the behavior data fee collection system (No. 2);

FIG. 5 is a flowchart showing the process of the mass behavior data generation unit;

FIG. 6 shows another configuration of the behavior data fee collection system (No. 3);

FIG. 7 is a flowchart showing the process of the behavior script process unit;

FIG. 8 is a flowchart showing the process of the place (facility) data acquisition unit;

FIG. 9 is a flowchart showing the process of the behavior data generation unit;

FIG. 10 is a flowchart showing the process of the behavior data fee calculation unit;

FIG. 11 is a flowchart showing the process of the fee collection unit;

FIG. 12 shows another configuration of the behavior data fee collection system (No. 4);

FIG. 13 shows another configuration of the behavior data fee collection system (No. 5);

FIG. 14 is a flowchart showing the process of the facility data registration unit;

FIG. 15 is a flowchart showing the process of the registration fee calculating unit;

FIG. 16 is a flowchart showing the process of the behavior script generation unit;

FIG. 17 shows another configuration of the behavior data fee collection system (No. 6);

FIG. 18 is a flowchart showing the process of a behavior script-embedded fee calculation unit;

FIG. 19 shows another configuration of the behavior data fee collection system (No. 7);

FIG. 20 is a flowchart showing the process of the information acquisition unit;

FIG. 21 is a flowchart showing the process of the charging unit;

FIG. 22 shows another configuration of the behavior data fee collection system (No. 8);

FIG. 23 shows another configuration of the behavior data fee collection system (No. 9);

FIG. 24 is a flowchart showing the process of a location/estimated route transmitting unit;

FIG. 25 is a flowchart showing the process of the user situation acquisition unit;

FIG. 26 is a flowchart showing the process of a data retrieval unit;

FIG. 27 shows another configuration of the behavior data fee collection system (No. 10);

FIG. 28 shows another configuration of the behavior data fee collection system (No. 11);

FIG. 29 is a flowchart showing the process of the travel data acquisition unit;

FIG. 30 is a flowchart showing the process of a facility utilization data acquisition unit;

FIG. 31 is a flowchart showing the process of a data matching unit;

FIG. 32 is a flowchart showing the process of the configuration shown in FIG. 27 or 28;

FIG. 33 shows another configuration of the behavior data fee collection system (No. 12);

FIG. 34 shows one configuration of amass behavior data utilization system;

FIG. 35 is a flowchart showing the process of a commodity development unit;

FIG. 36 is a flowchart showing the process of an information service unit;

FIG. 37 is a flowchart showing the process of an advertisement unit;

FIG. 38 shows the system configuration of the first preferred embodiment;

FIG. 39 shows the system configuration of the second preferred embodiment;

FIG. 40 shows the system configuration of the third preferred embodiment;

FIG. 41 shows the system configuration of the fourth preferred embodiment;

FIG. 42 shows the system configuration of the fifth preferred embodiment;

FIG. 43 shows the system configuration of the sixth preferred embodiment; and

FIG. 44 shows the system configuration of the seventh preferred embodiment.

### DETAILED DESCRIPTIONS OF THE PREFERRED EMBODIMENTS

The present invention implements a system for trading behavior data comprising means for obtaining behavior data, means for recording/storing the obtained behavior data and means for calculating the fee of the recorded/stored behavior data and selling the behavior data using a computer, generates both behavior data and mass behavior data obtained by collecting a plurality of pieces of behavior data and solves the problems described above by providing an application technology to a computer system for trading both pieces of the data. In this case, effective data as mass marketing data can be obtained by recording the obtained behavior data together with a user attribute, etc., and making behavior data about when, where and in what order a person with a specific attribute goes.

For example, if a specific user takes behavior of “dining at an Italian restaurant and visiting a place where a night scenery can be observed after an amusement park, such behavior data are collected and stored. If as a result of analyzing the stored data, it is found that couples in twenties have the similar behavior pattern, one set of a ticket for an amusement park, a discount coupon for an Italian dish and a ticket for the observatory of a building with a beautiful night scenery can be put on the market. Such a service not only is welcomed by a user, but is also effective for a ticket seller.

The purchase histories of many customers are collected in advance and purchased commodities are categorized for each customer attribute. If commodities purchased by people belonging to the same category as a specific customer are recommended when the customer “tries to buy a specific commodity, such a service not only is helpful for the customer, but it is also a very effective sales strategy for a seller.

Similarly, if a piece of behavior or a destination taken by people belonging to the same attribute category is also recommended when a specific user “tries to do something”, such a service not only is helpful for the user, but a service provider can also sell a combination of a plurality of plans.

The problems described above can be solved by preparing behavior script generation means for generating a behavior scrip using both facility data registration means and facility data to provide each facility with information and to present a user information about each facility when a user uses the behavior script, introducing a fee calculation unit to utilize this service and providing the application technology for a computer system to establish such service as business.

The preferred embodiments of the present invention are described below.

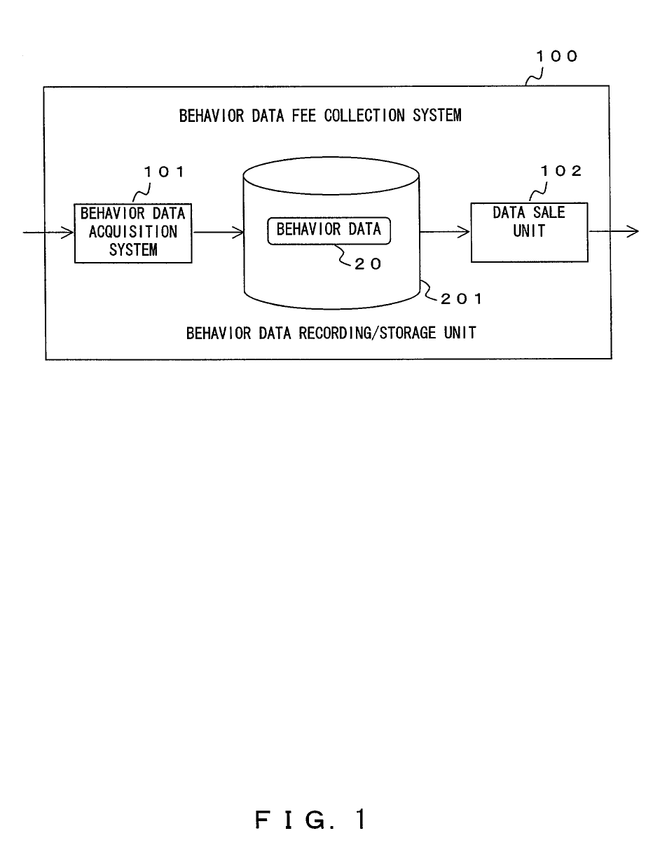

FIG. 1 shows one configuration of the behavior data fee collection system (No.1). A behavior data fee collection system 100 is a computer system composed of a CPU, a memory, a software program, etc., and comprises a behavior data acquisition unit 101 obtaining behavior data 20, a behavior data recording/storage unit 201 recording/storing the obtained behavior data 20 and a data sale unit 102 calculating the fee of the stored data and selling the data.

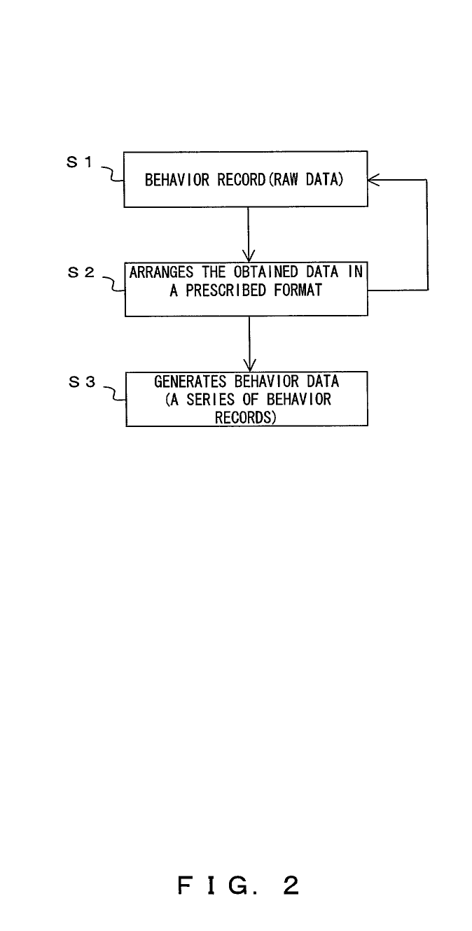

As shown in FIG. 2, the behavior data acquisition unit 101, receives, for example, the behavior record of a user (raw data), such as the location data of a user (step S1), arranges the obtained data in a prescribed format (step S2) and generates behavior data 20, which are a series of behavior records (step S3). The unit 101 writes the behavior data 20 in the behavior data recording/storage unit 201.

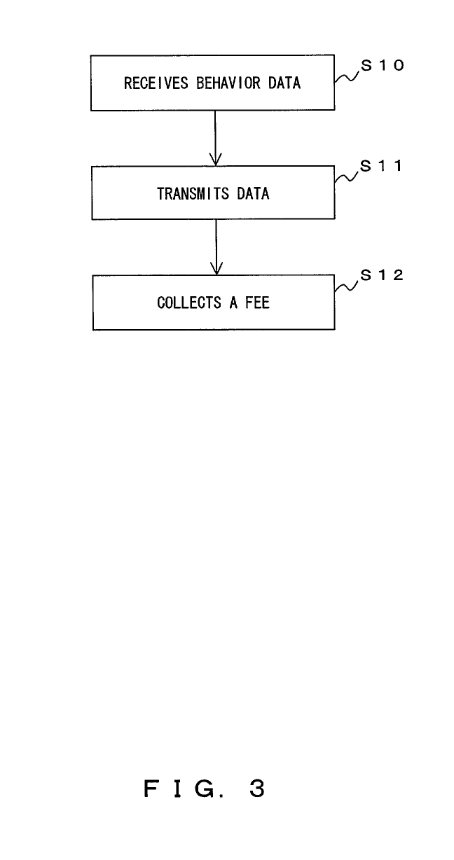

As shown in FIG. 3, on receipt of the behavior data 20 stored in the behavior data recording/storage unit 202 (step S10), the data sale unit 102 transmits the data to a prescribed purchaser (step S11), claims a price fixed against the data and collects the fee (step S12).

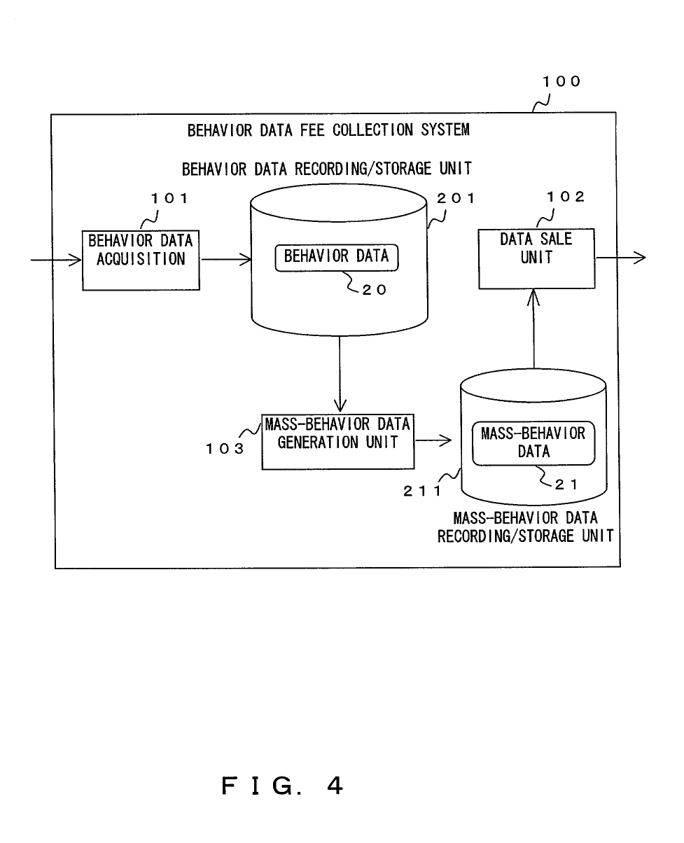

FIG. 4 shows another configuration of the behavior data fee collection system (No.2). The behavior data fee collection system 100 comprises a behavior data acquisition unit 101 obtaining behavior data 20, a behavior data recording/storage unit 201 recording/storing the obtained behavior data 20, a mass behavior data generation unit 103 generating mass behavior data 21 by collecting and statistically processing a plurality of pieces of the stored behavior data 20, a mass behavior data recording/storage unit 211 recording/storing the generated mass behavior data 21 and a data sale unit 102 calculating the fee of the mass behavior data 21 and selling the data.

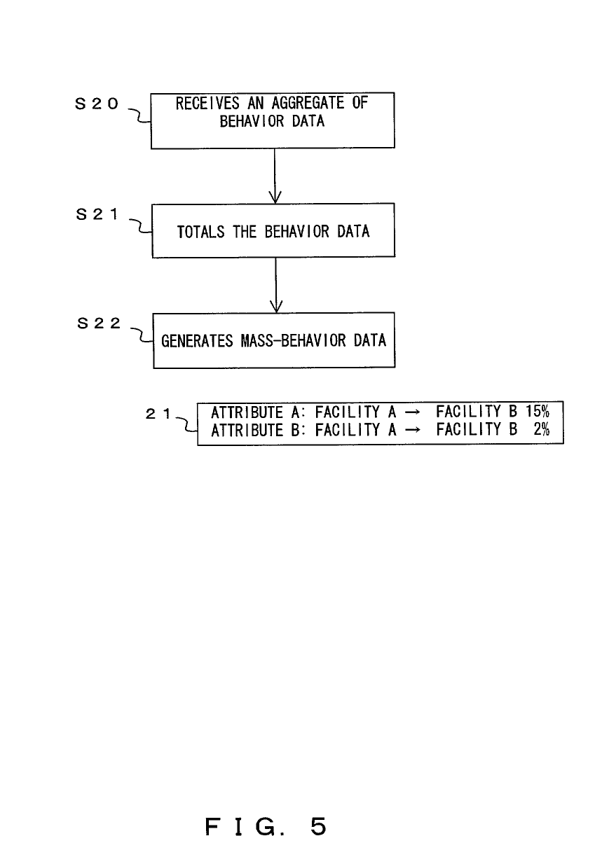

Both the behavior data acquisition unit 101 and data sale unit 102 operates in the same way as those shown in FIG. 1. As shown in FIG. 5, on receipt of the aggregate of behavior data 20 (step S20), the mass behavior data generation unit 103 totals a plurality of pieces of behavior data for each predetermined attribute (step S21) and generates mass behavior data 21 (step S22). The mass behavior data 21 are, for example, data that 15% of persons with attribute A go from facility a to facility b and 2% of persons with attribute B go from facility a to facility b.

By providing means for detecting a combination of a plurality of pieces of behavior frequently made from the behavior data obtained by the behavior data acquisition unit 101 and providing information about or advertising the same combination of behavior when a user takes one of the plurality of pieces of behavior, the provision of effective information or advertisement can also be implemented as an application of this system.

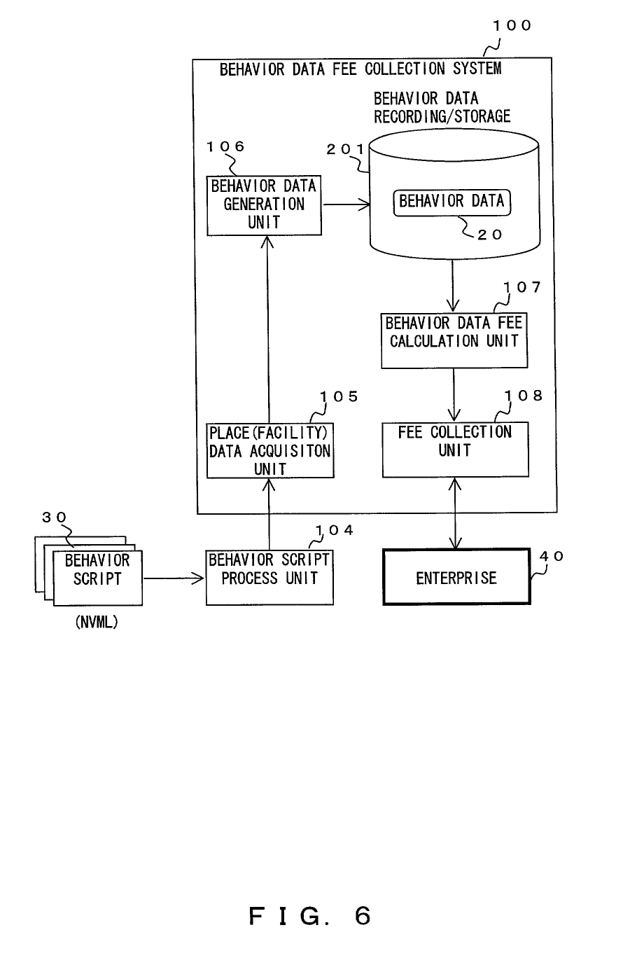

FIG. 6 shows another configuration of the behavior data fee collection system (No.3). The behavior data fee collection system 100 comprises a behavior script process unit 104 processing behavior script 30, a place (facility) data acquisition unit 105 obtaining place data (facility data) about places and facilities transmitted from the behavior script process unit 104, a behavior data generation unit 106 collecting facility data and generating behavior data 20, a behavior data recording/storage unit 201 recording/storing the generated behavior data 20, a behavior data fee calculation unit 107 calculating the fee of behavior data 20 and a fee collection unit 108 collecting a fee from an enterprise 40 purchasing the behavior data 20.

The behavior script 30 is data in which a paired series of at least place information and/or time information and information provided to a user depending on a time and/or place to be presented, and both the names of facilities visited by a specific user and the visiting order can be described in the script. This behavior script 30 can be generated by a planning agency or travel agency, can be generated in advance by an individual or can be automatically generated by designating requirements.

The data described based on the prescribed usage is a series of instructions described according to a prescribed specification that can be described by the combination of a description and the content of the information for distinguish time information and/or place information from the guidance information to be outputted depending on both a time and/or place to be presented. An instruction is the unit of a script composed of guidance information, including a time (for example, departure time, passing time, arrival time, starting time, finishing time, etc.), a place (for example, starting point, passing point, finishing point, intersection, exchanging point, location of a facility, etc.) and/or both one shot and partial data of each type of media data (map, character, voice, music, image, video, etc.).

The behavior scrip process unit 104 is used to perform a series of processes based on a behavior script 30 and can navigate a user according to a behavior plan described in the behavior script 30. The unit 104 can also obtain the current location of a user, and if the user arrives at a facility described in the behavior script 30, the unit 104 can notify a center, etc., of the arrival. For both this behavior script 30 and behavior script process unit 104, the process technology of the guidance script disclosed in the Japanese Patent Laid-open No.2000-215211 can be used.

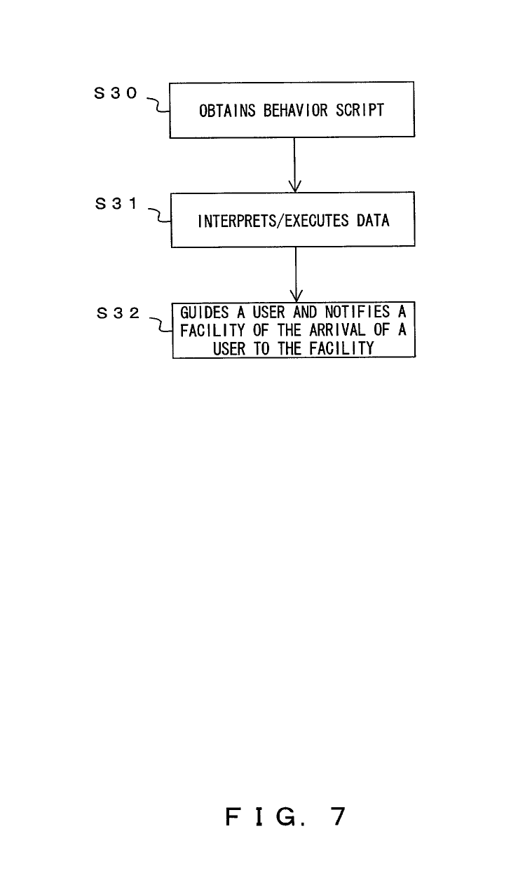

As shown in FIG. 7, the behavior script process unit 104 first obtains a behavior scrip 30 to be executed (step S30) and interprets/executes the script data (step S31). In this way, characters, images, etc., are displayed or announced to a user, and the arrival of a user at each facility, etc., is reported to each facility (step S32).

The place (facility) data acquisition unit 105 obtains the location of a user or information about a facility visited by the user, based on data from the behavior script process unit 104. If a piece of behavior taken at a facility by a user (the purchase of something, etc.,) can be obtained, the unit 105 also obtains such information.

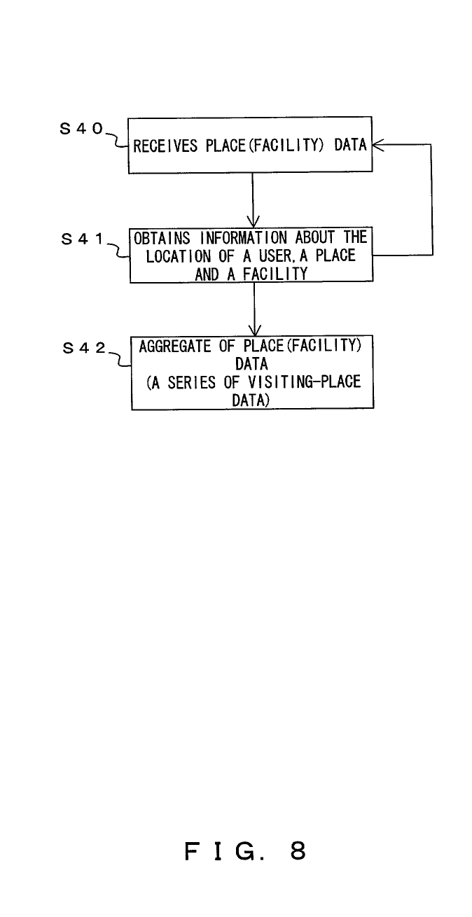

As shown in FIG. 8, the place (facility) data acquisition unit 105 sequentially receives place (facility) data from the behavior script process unit 104 (step S40), obtains the location of a user, data about a place or facility, etc., (step S41) and makes an aggregate of a series of place (facility) data of the obtained data (step S42).

The behavior data generation unit 106 generates behavior data 20 from the aggregate of place (facility) data inputted from the place (facility) data acquisition unit 105. In this case, behavior data 20 are data in which information about facilities visited by a specific user, the visiting order and behavior taken there by the user are described.

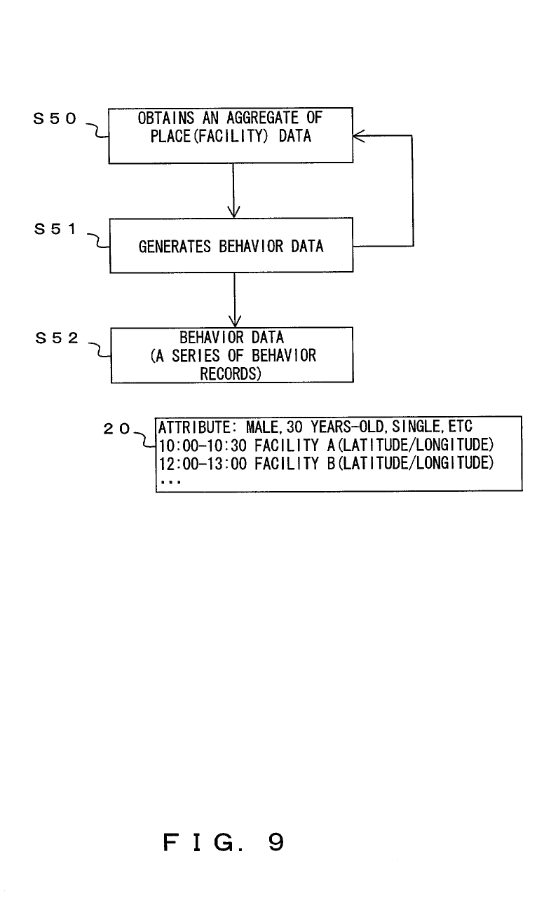

As shown in FIG. 9, on receipt of the aggregate of place (facility) data (step S50), the behavior data generation unit 106 generates behavior data 20 based on the aggregate (step S51). The unit 106 repeats this process and outputs behavior data 20, which are a series of behavior records of a specific user (step S52). The data are, for example, data that a single man of 30 years old has stayed in facility A from 10 o'clock until 10 o'clock and a half, then has stayed in facility B from 12 o'clock until 13 o'clock, etc.

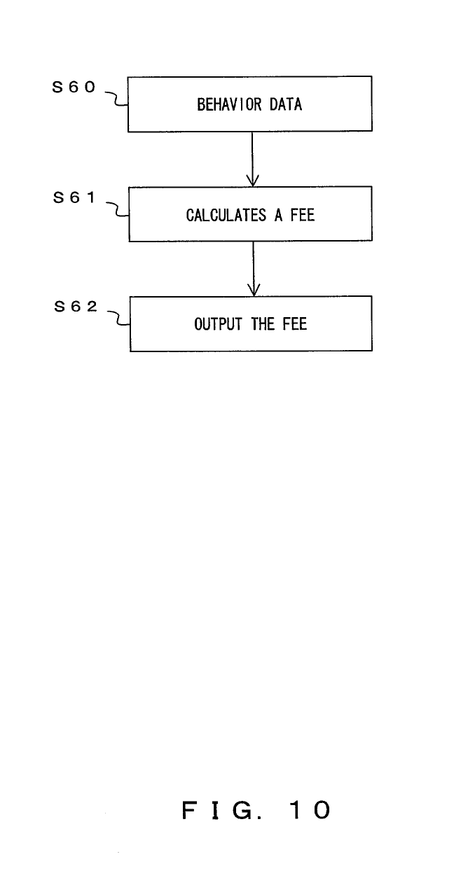

As shown in FIG. 10, the behavior data fee calculation unit 107 reads behavior data 20 stored in the behavior data recording/storage unit 210 (step S60), calculates a fee based on a prescribed standard (step S61) and outputs the calculated fee (step S62).

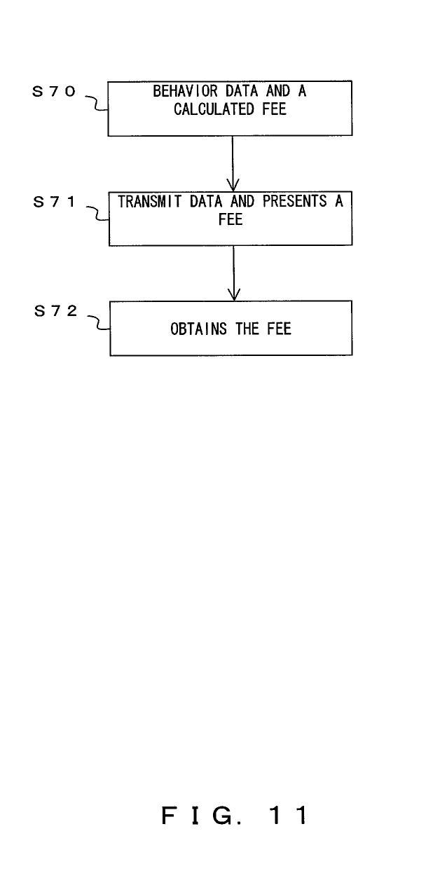

As shown in FIG. 11, when obtaining both the behavior data 20 and the calculated fee (step S70), the fee collection unit 108 transmits the behavior data 20 and presents the fee to a requesting enterprise 40 (step S71), and collects the fee from the enterprise 40 that has purchased the data (step S72).

Both the behavior data fee calculation unit 107 and fee collection unit 108 flexibly respond to situations by collectively trading depending on the content of a contract and modifying a fee depending on how to use the data. For the collection method of a fee, an electronic settlement technology can also be used.

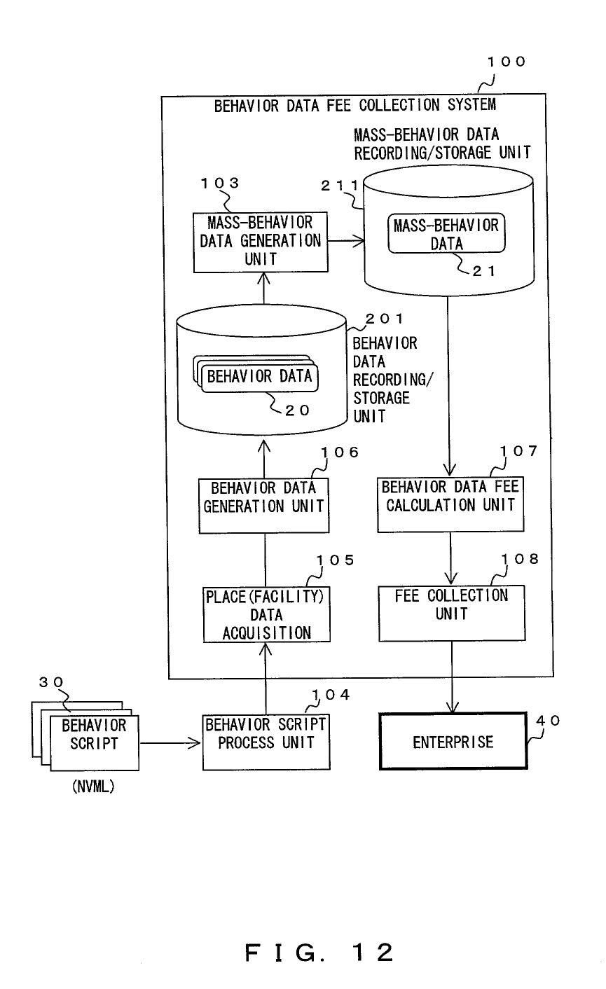

FIG. 12 shows another configuration of the behavior data fee collection system (No.4). Trading individual behavior data without any process has a problem from a viewpoint of privacy. Therefore, in this configuration, a mass behavior data generation unit 103 is added to the configuration shown in FIG. 6. In this case, the mass behavior data generation unit 103 can generates mass behavior data 21 for indicating the behavior tendency of many persons as statistical data, such as data that “persons going from facility A to facility B and persons going from facility A to facility C are 10% and 5%, respectively, and can trade the mass behavior data 21.

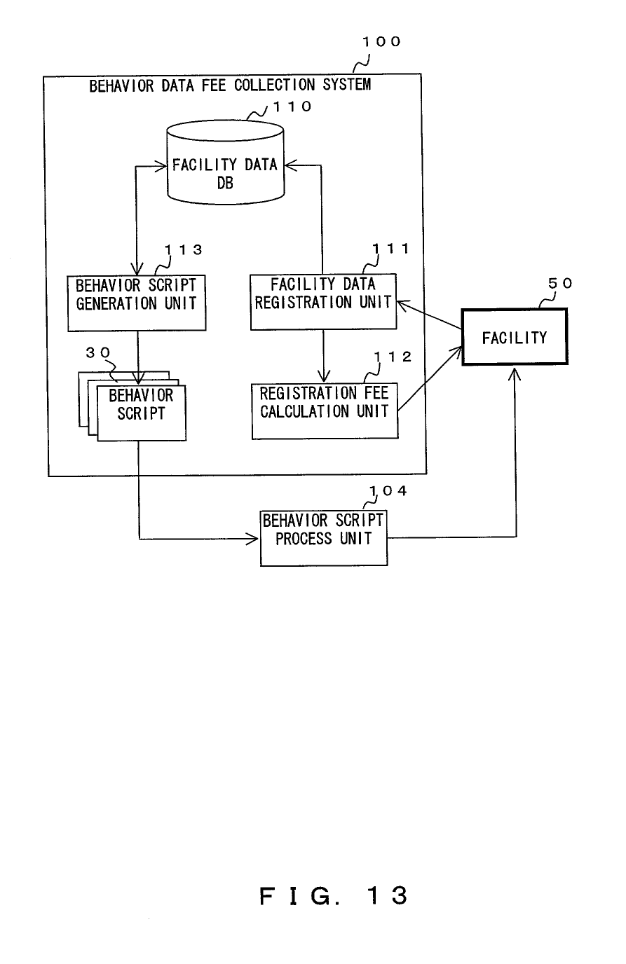

FIG. 13 shows another configuration of the behavior data fee collection system (No.5). This configuration comprises a facility data registration unit 111 registering a variety of data (facility data) about facilities 50 that might be visited by a user in a facility data DB 110, a registration fee calculating unit 112 calculating a fee fixed against the registration when the data are registered and a behavior script generation unit 113 generating behavior script 30 using the registered facility data.

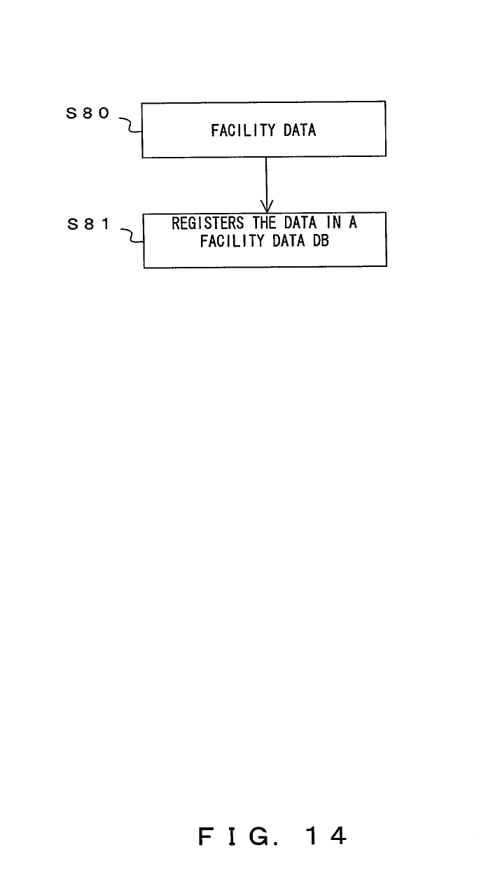

As shown in FIG. 14, the facility data registration unit 111 obtains facility data, such as place information of the facility 50 (latitude, longitude, address, etc.), contact information (phone number, e-mail address, URL, etc.), guidance information (advertisement, how to go, introduction text/image, etc.), guidance display conditions (geographical scope for guidance display, the attribute of a target user for guidance display, etc.), etc., (step S80) and registers the data in the facility data DB 110 (step S82).

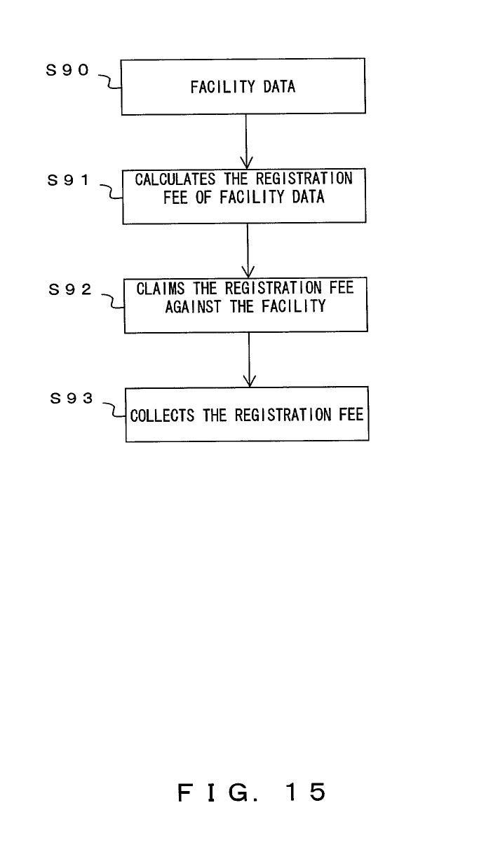

At this moment, as shown in FIG. 15, when obtaining the facility data (step S90), the registration fee calculating unit 112 calculates the registration fee of the data in accordance with a standard predetermined depending on a geographical scope for guidance display, etc., (step S91), claims the registration fee against the facility 50 (step S92) and collects the registration fee (step S93).

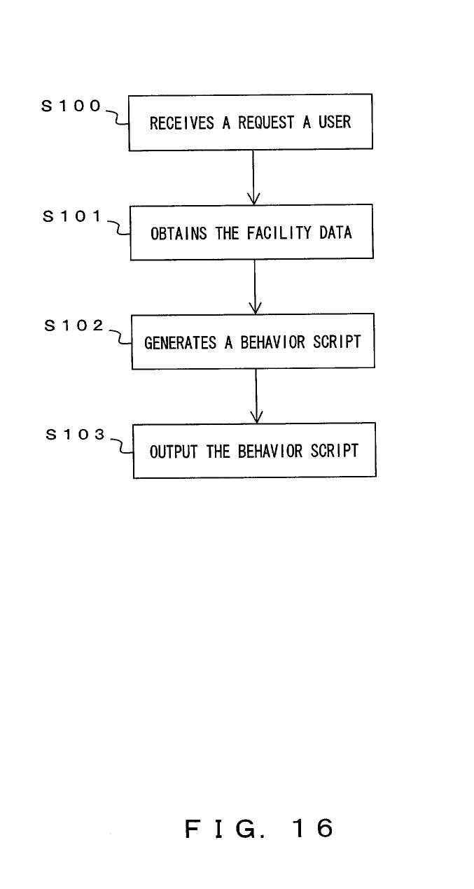

As shown in FIG. 16, on receipt of a request from a user (step S100), the behavior script generation unit 113 obtains facility data from the facility data DB 110 (step S101) and generates a behavior script 30 (step S102). For example, the unit 113 enables a user to select an appropriate behavior script 30 by the user selecting a genre or automatically generates a behavior script 30 by a user setting a starting place, a destination and several passing points. In this case, the unit 113 takes information stored in the facility data DB 110 in the behavior script 30 by displaying information about a facility registered in the facility data DB 110, making the user select a facility from the facilities, automatically inserting information about facilities related to the facility in the course in the automatically generated behavior script 30. Then, the unit 113 outputs the generated behavior script 30 (step S103).

By processing the behavior script 30 generated in this way by the behavior script process unit 104, the guidance information about a facility 50 can be displayed or arrival at the facility can be reported to facilities to be visited later when a user arrives at the relevant place.

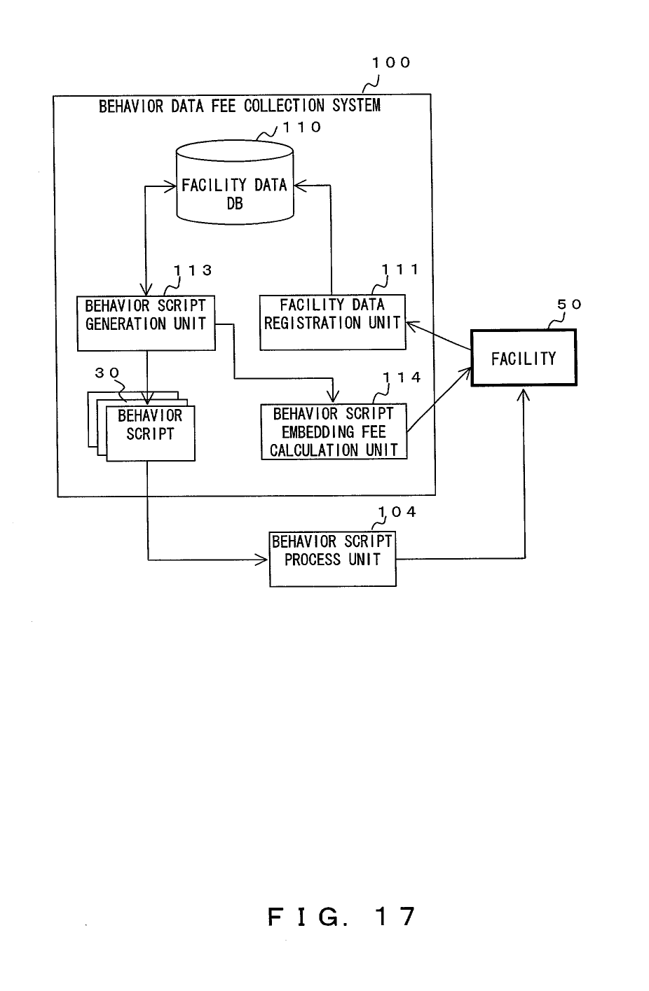

FIG. 17 shows another configuration of the behavior data fee collection system (No.6). Although this configuration generates a behavior script 30 like the configuration shown in FIG. 13, the configuration charges when a behavior script 30 is generated using facility data instead of when the facility data is registered. This configuration comprises a behavior script-embedded fee calculation unit 114 instead of the registration fee calculation unit 112 in the configuration shown in FIG. 13.

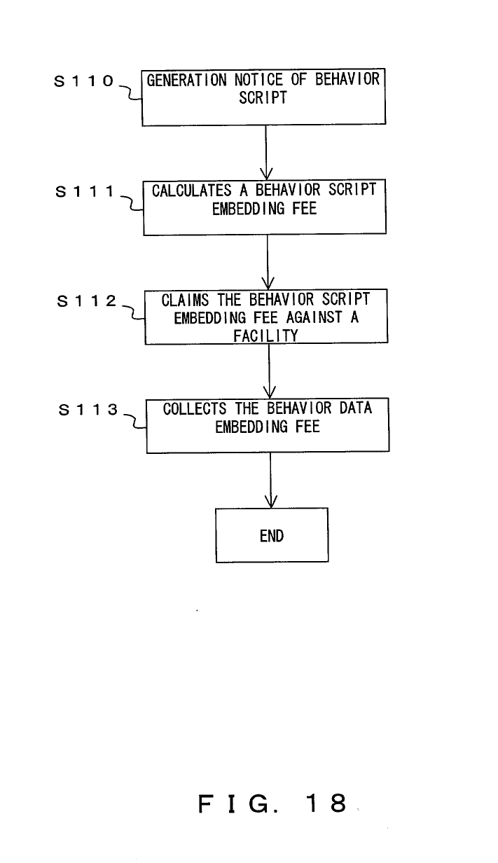

As shown in FIG. 18, on receipt of the generation notice of a behavior script from the behavior script generation unit 113 (step S110), the behavior script-embedded fee calculation unit 114 calculates behavior script-embedded fee according to a prescribed standard (step S111), claims the behavior scrip-embedded fee against a facility 50, the relevant data of which are registered, (step S112) and collects the behavior script-embedded fee (step S113).

By adopting such a configuration, a fee is charged based on the total number of lines embedded in an actually generated behavior script 30. Therefore, a fairer fee can be set.

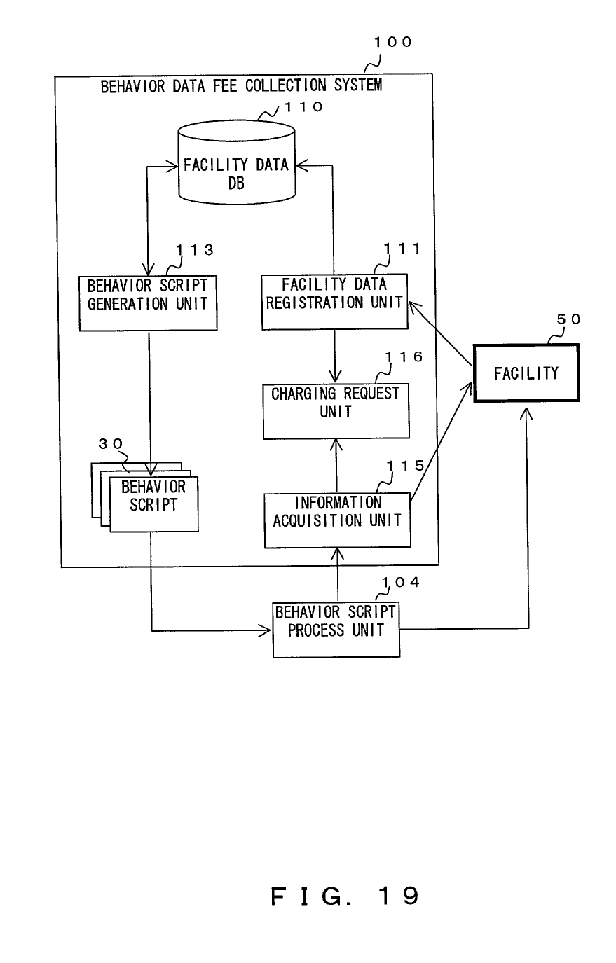

FIG. 19 shows another configuration of the behavior data fee collection system (No.7). Although this configuration generates a behavior script 30 like the configuration shown in FIG. 13, a fee is charged when the behavior script process unit 104 presents the guidance information of a facility 50 or when the arrival is reported to the facility 50. This configuration comprises an information acquisition unit 115 and a charging unit 116 instead of the registration fee calculation unit 112 in the configuration shown in FIG. 13.

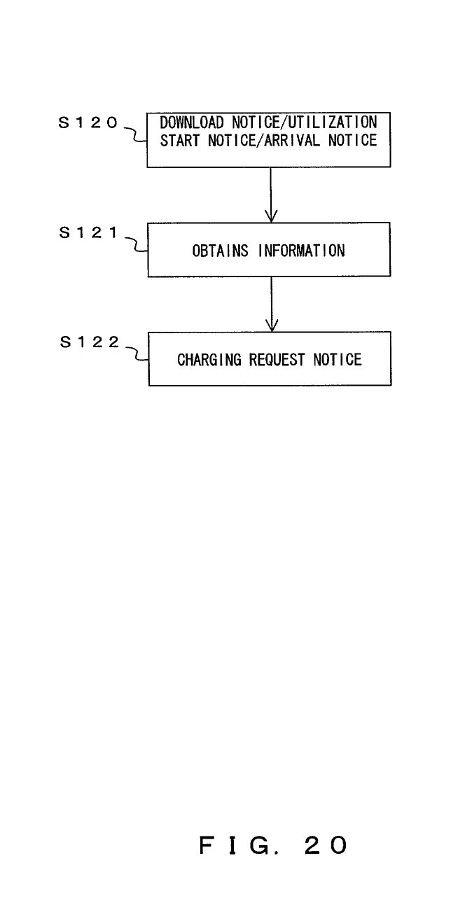

As shown in FIG. 20, when actually guidance information about a facility 50 is presented or the facility 50 is reported, such as when the behavior script process unit 104 downloads data and/or starts using data and/or notifies the facility 50 of the arrival at the time of data process or when guidance (advertisement) on the facility is presented to a user (step S120), the information acquisition unit 115 obtains information issued at that moment (step S121) and requests the charging unit 116 to charge a fee (step S122).

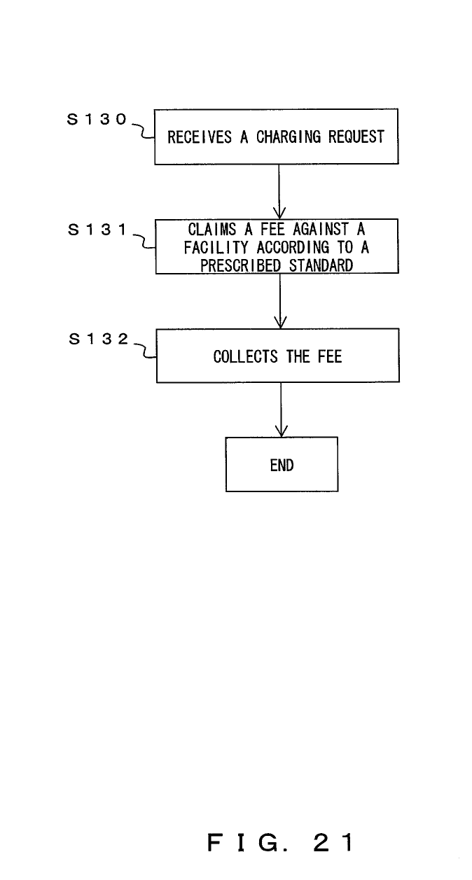

As shown in FIG. 21, on receipt of the charge request (step S130), the charging unit 116 claims the fee against the facility 50 according to a prescribed standard (step S131) and collects the fee by an electronic settlement or another means (step S132).

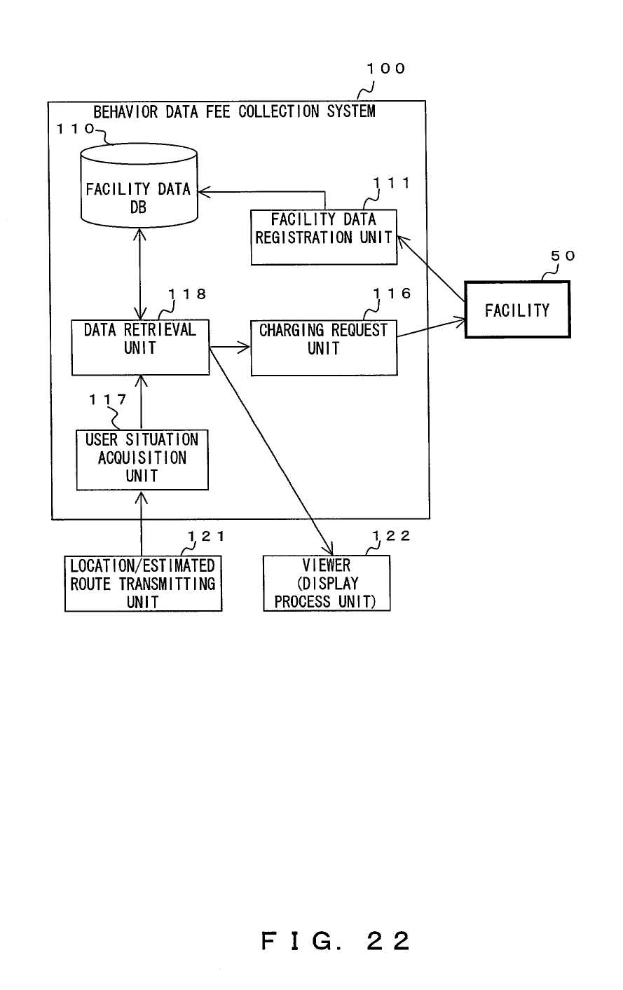

FIG. 22 shows another configuration of the behavior data fee collection system (No.8). According to the system with this configuration, if a user transmits the current location and the location of a destination or a route from the current location to the destination using a location/estimated route transmitting unit 121, a user situation acquisition unit 117 obtains the current location and destination of the user, and information about a route taken from now on by the user, a data retrieval unit 118 retrieves both the current location and destination of the user, and information related to the route estimated to be taken by the user, from the facility data DB 110, based on the obtained information and provides facility data to the user by presenting the retrieval result to the viewer (display process unit) 122 of the user. This system comprises a facility data registration unit 111 and registers facility data in the facility data DB 110. When data are downloaded, when the use of data is started and when data a reprocessed or when the viewer (display process unit) 122 presents guidance (advertisement) to the user, the charging unit 116 charges a fee against the facility 50.

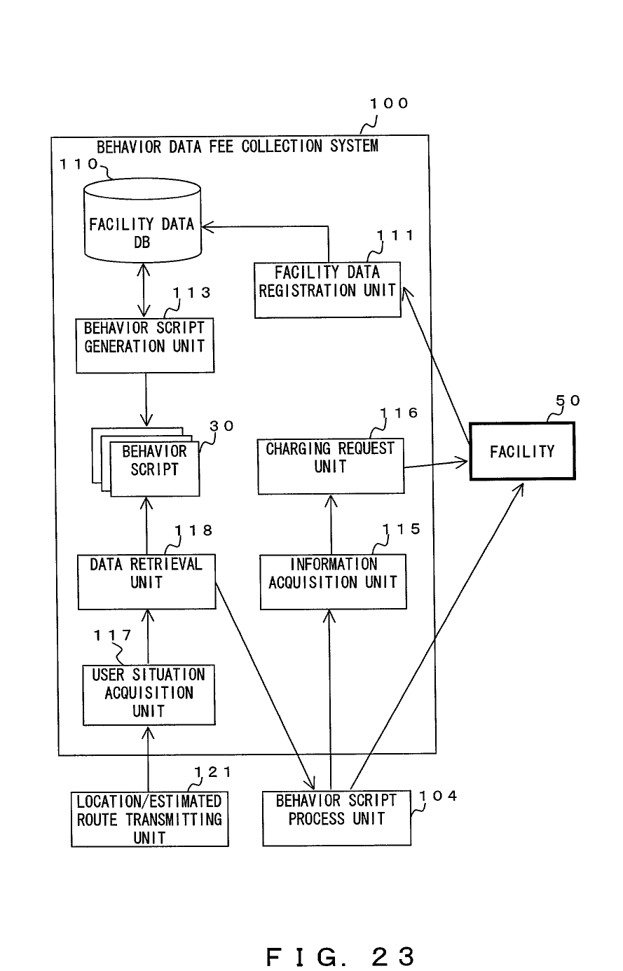

FIG. 23 shows another configuration of the behavior data fee collection system (No.9). Although this configuration is almost the same as that shown in FIG. 22, this configuration differs from that shown in FIG. 22 in that a behavior script 30 is provided to a user instead of data. The data retrieval unit 118 searches for a behavior script 30 generated by the behavior script generation unit 113 depending on the situation of the user.

When data are registered, when data are downloaded, when the use of data is started, when a user reports to a facility 50 or when guidance (advertisement) on the facility 50 is presented to a user, the charging unit 116 charges a fee against the facility 50.

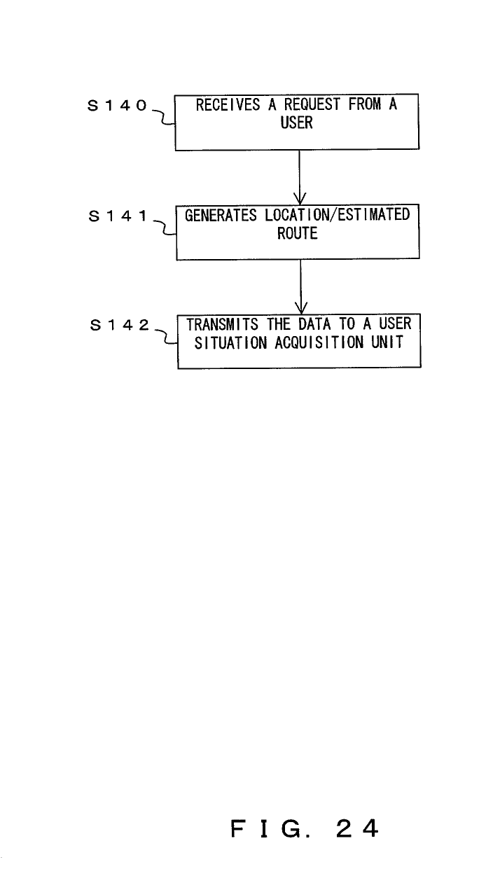

In the configuration shown in FIG. 22 or 23, as shown in FIG. 24, on receipt of a request from a user (step S140), the location/estimated route transmitting unit 121 generates a location or estimated route (step S141) and transmits the location/estimated route of the user to the user situation acquisition unit 117 (step S142). A user's request can be transmitted/received, as example, as text information described in a language for describing a behavior script.

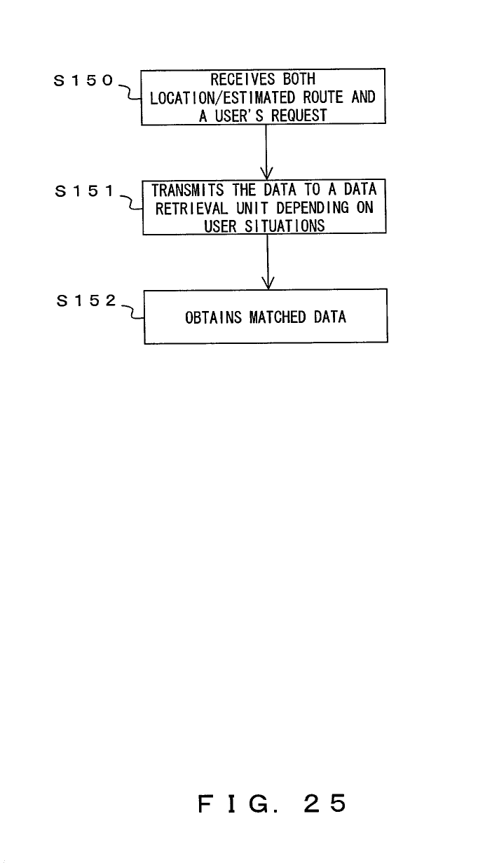

As shown in FIG. 25, on receipt of both the location/estimated route and user's request (step S150), the user situation acquisition unit 117 transmits both the location/estimated route and user's request to the data retrieval unit 118 (step S151) and obtains matched data from the data retrieval unit 118 (step S152).

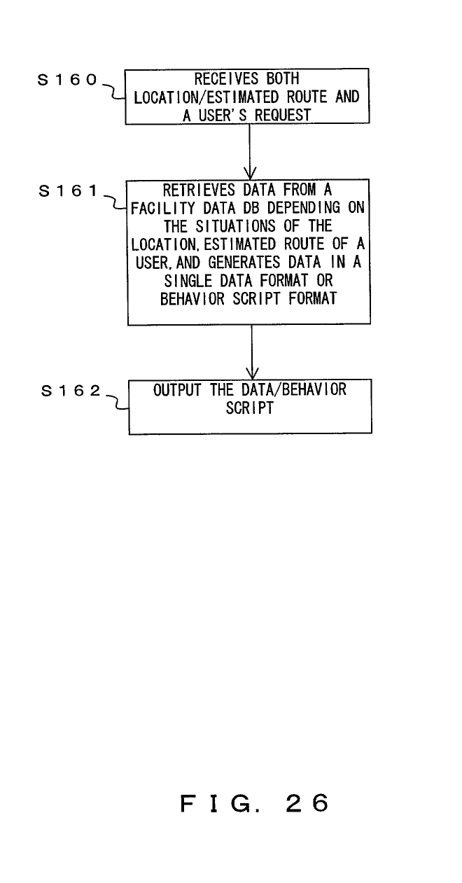

As shown in FIG. 26, on receipt of both the location/estimated route and user's request (step S160), the data retrieval unit 118 retrieves data from the facility data DB 110 depending on the situations of the user's location, the estimated route, etc., generates data or a behavior script 30 from the retrieval result in a single data format or behavior script format (step S161) and outputs the data or behavior script 30 (step S162).

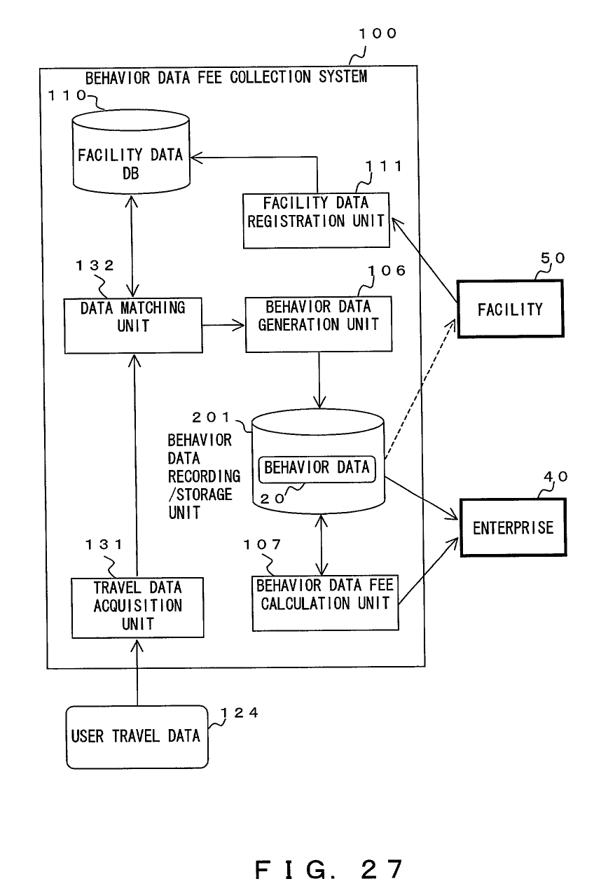

FIG. 27 shows another configuration of the behavior data fee collection system (NO.10). In the case of this configuration, as in the case of the configuration shown in FIG. 13, when there is a request, etc., from a facility 50, the facility data registration unit 111 stores in advance information about the location of the facility in the facility data DB 110. Every time the travel data acquisition unit 131 obtains user's travel data 124, the data matching unit 132 matches the user's travel data 124 with the information about the location of the facility registered in the facility data DB 110. The matched data are transmitted to the behavior data generation unit 106. The behavior data generation unit 106 generates behavior data by arranging/unifying the data. The generated behavior data 20 are stored in the behavior data recording/storage unit 201. The behavior data fee calculation unit 107 sets a fee in the behavior data 20 according to a prescribed standard, transmits the data to a requesting enterprise 40 and collects the fee.

As in the case of the configuration shown in FIG. 12, mass behavior data 21 can also be generated by totaling a plurality of pieces of behavior data 20 and can be sold instead of the behavior data 20.

Information indicating whether a user actually has visited a facility 50 or what facilities 50 the user has visited before and after the facility 50 can also be fed back to each of the facilities 50, the data of which are registered.

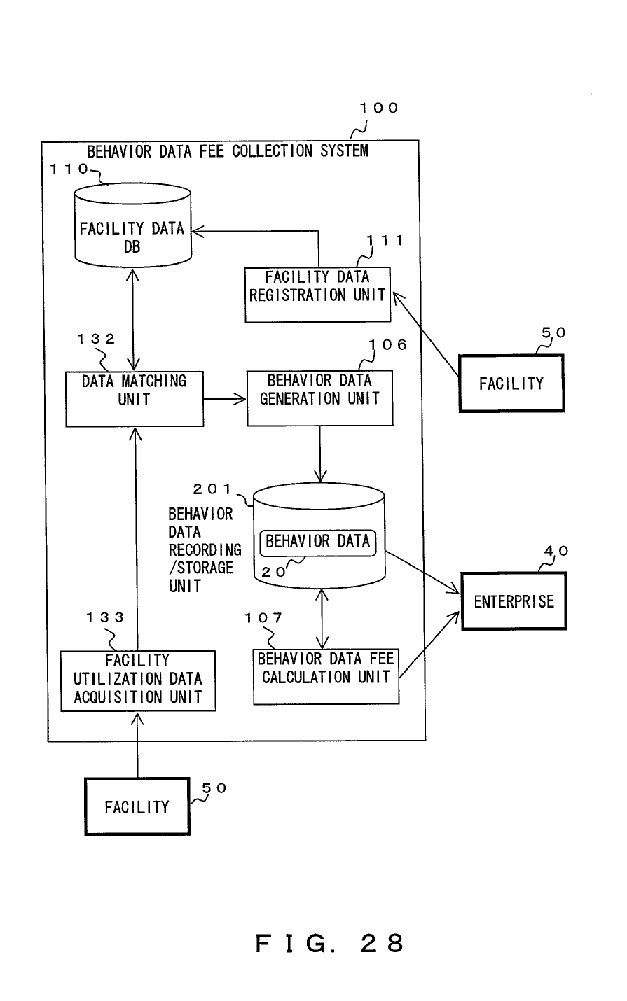

FIG. 28 shows another configuration of the behavior data fee collection system (NO.11). Although this configuration is almost the same as that shown in FIG. 27, the configuration differs from the configuration shown in FIG. 27 in that a facility utilization data acquisition unit 133 obtains facility utilization data (indicating the purchase of something, the ride on something, etc.) transmitted from a facility 50 instead of the user's travel data 124 and that the data matching unit 132 matches the facility utilization data with the facility data stored in the facility data DB 110.

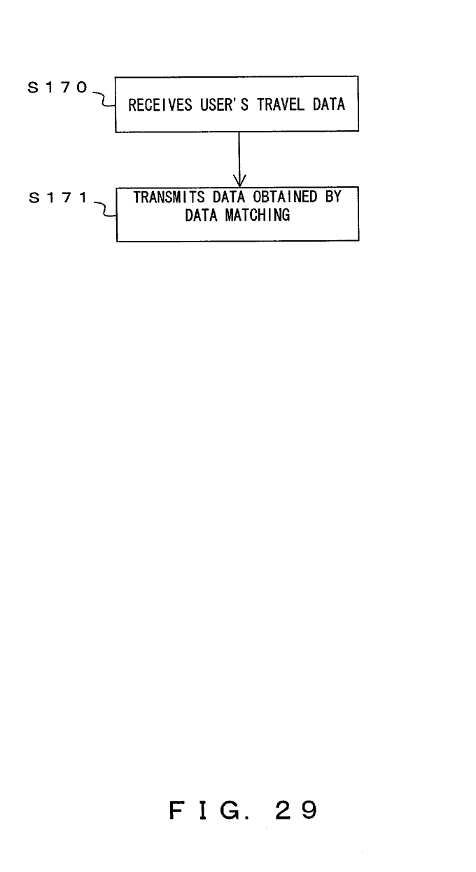

As shown in FIG. 29, on receipt of the user's travel data 124 (step S170), the travel data acquisition unit 131 shown in FIG. 27 transmits the obtained data to the data matching unit 132 (step S171).

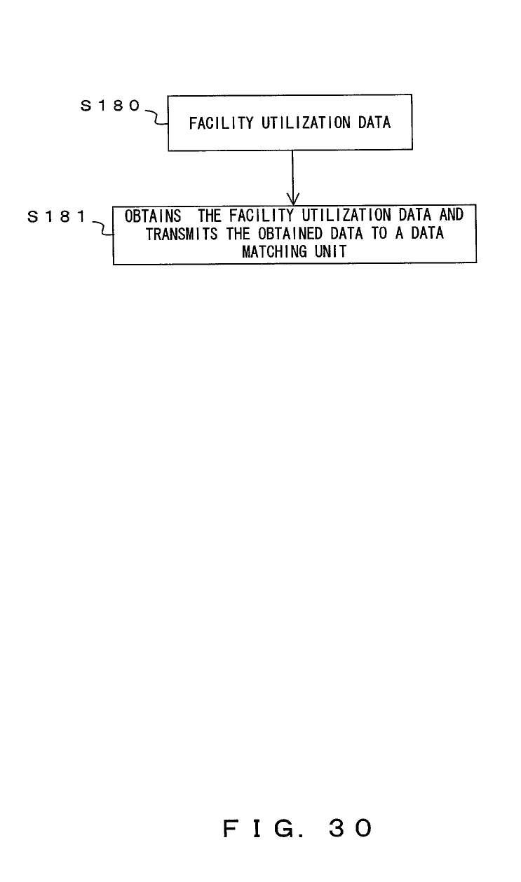

As shown in FIG. 30, on receipt of the facility utilization data of the user from a facility 50 (step S180), the facility utilization data acquisition unit 133 shown in FIG. 28 transmits the obtained data to the data matching unit 132 (step S181).

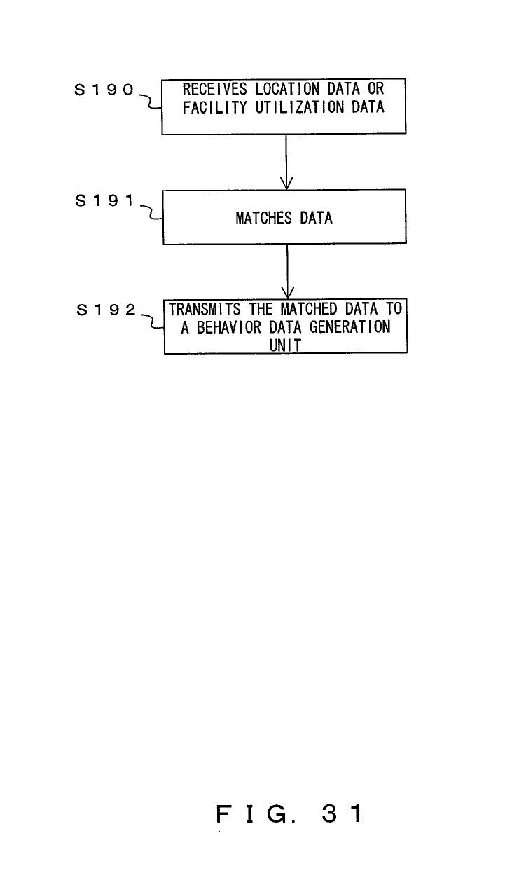

As shown in FIG. 31, on receipt of the location data from the travel data acquisition unit 131 or the facility utilization data from the facility utilization data acquisition unit 133 (step S190), the data matching unit 132 matches the received data with the data stored in the facility data DB 110 (step S191) and transmits the matched data to the behavior data generation unit 106 (step S192).

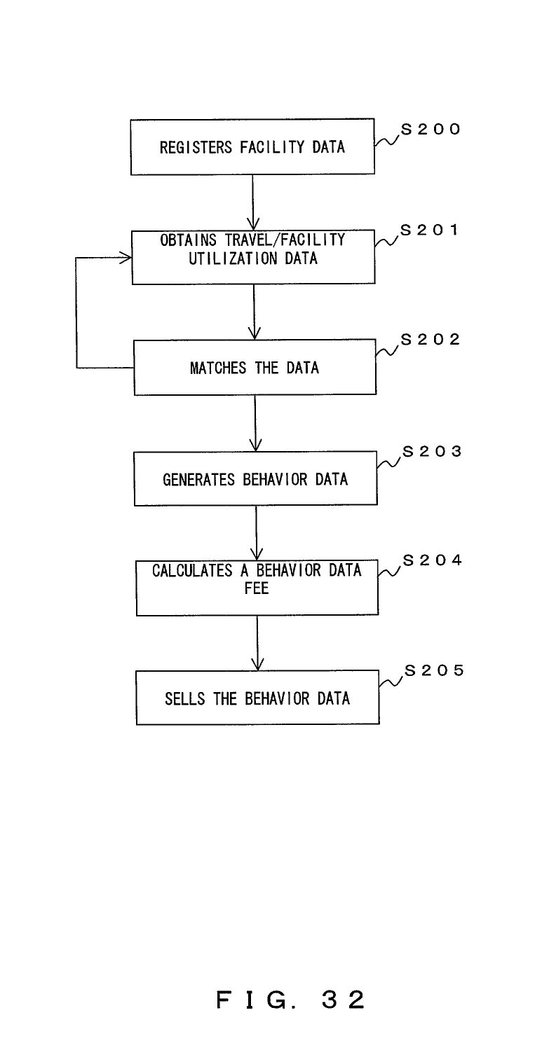

FIG. 32 is a flowchart showing the basic process in the configuration shown in FIGS. 27 and 28.

First, facility data are registered in advance in a facility data registration unit 111 (step S200). If a specific user travels, the travel data of a user (information about a place where the user has traveled) are obtained in some steps by a method for obtaining latitude/longitude information using a GPS (Global Positioning System), etc., or facility utilization data (information about a used facility) are obtained every time a facility has been used by a method for obtaining utilization information in conjunction with the terminal of a POS system installed in the facility 50 (step S201). Then, the data and the data registered in advance in the facility data DB 110 are compared and it is checked whether they are matched (step S202). Such processes (steps S201 and S202) are repeated from the start of a specific behavior of a user until the finish. Behavior data 20 are generated from both the travel records and utilization records stored in this way (step S203), the fee of the behavior data 20 is calculated (step S204) and the behavior data are sold to the requesting enterprise 40 (step S205).

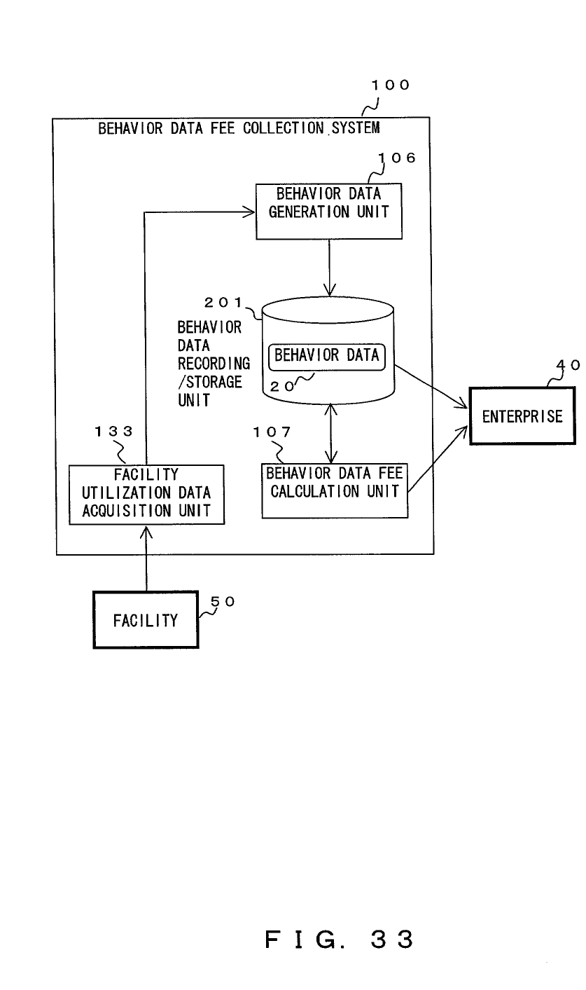

FIG. 33 shows another configuration of the behavior data fee collection system (NO.12). If as in the case of this configuration, the facility utilization data acquisition unit 133 can obtain facility utilization data from a facility 50, the facility utilization data acquisition unit 133 can also generate behavior data 20 from facility utilization data without registering facility data in advance, and a behavior data fee calculation unit 107 can also calculate the fee of the behavior data 20.

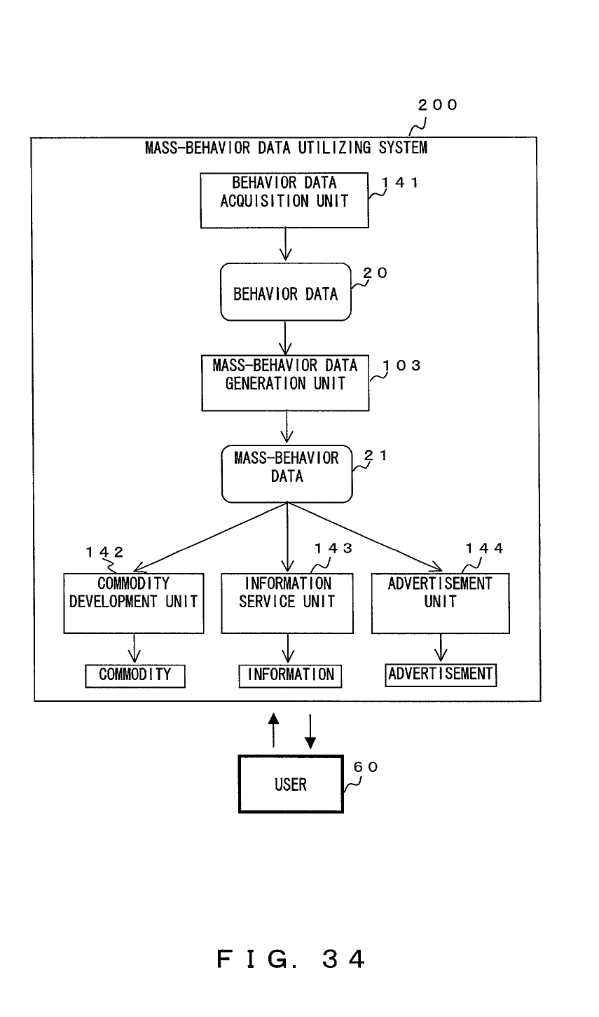

FIG. 34 shows one configuration of the mass behavior data utilization system. In this system, commodity development, the provision of information services or advertisement is conducted using generated mass behavior data 21.

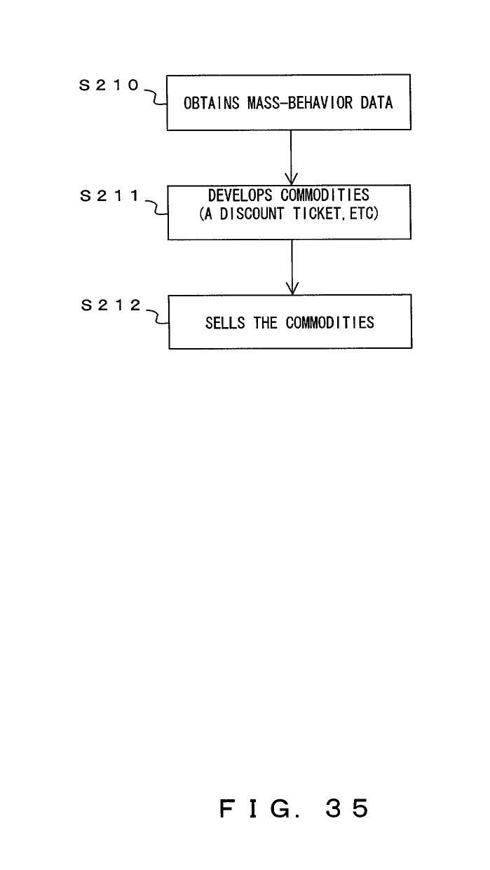

The mass behavior data utilization system 200 obtains the behavior data of a user using a behavior data acquisition unit 141 and conducts commodity development, information provision service and advertisement based on mass behavior data 21 generated from the obtained behavior data 20 using amass behavior data generation unit 103. For example, as shown in FIG. 35, a commodity development unit 142 obtains mass behavior data 21 (step S210), plans/develops commodities, such as a discount ticket in which commodities required to implement a specific series of behavior patterns, the discount tickets of facilities included in the mass behavior data 21, etc., are set, a tour for implementing the behavior patterns of the mass behavior data 21, etc., (step S211), and sells these commodities (step S212).

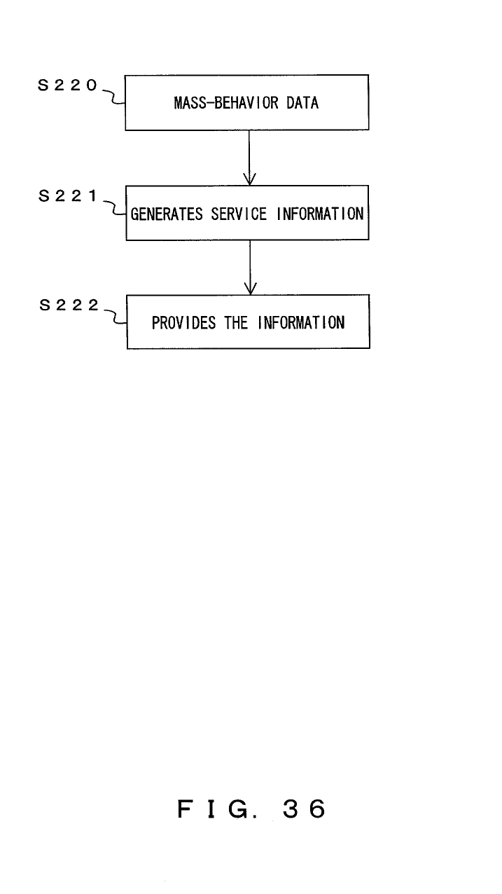

As shown in FIG. 36, an information service unit 143 obtains mass behavior data 21 (step S220), generates information required to implement the behavior pattern (step S221) and provides the information (step S222).

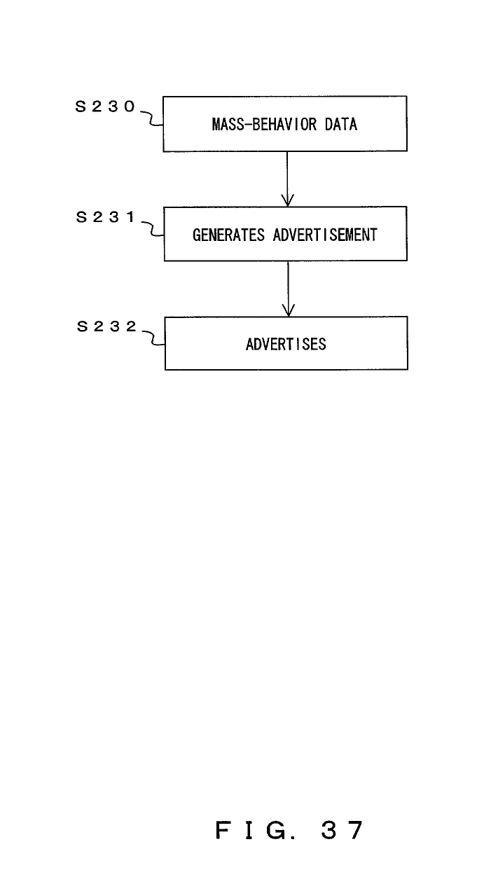

As shown in FIG. 37, an advertisement unit 144 obtains mass behavior data 21 (step S230) and generates advertisement matching the behavior pattern (step S231) and advertises commodities using the generated advertisement (step S232).

Next, the detailed preferred embodiments of the present invention are described. The present invention is especially effective if it is implemented in center services.

[The First Preferred Embodiment]

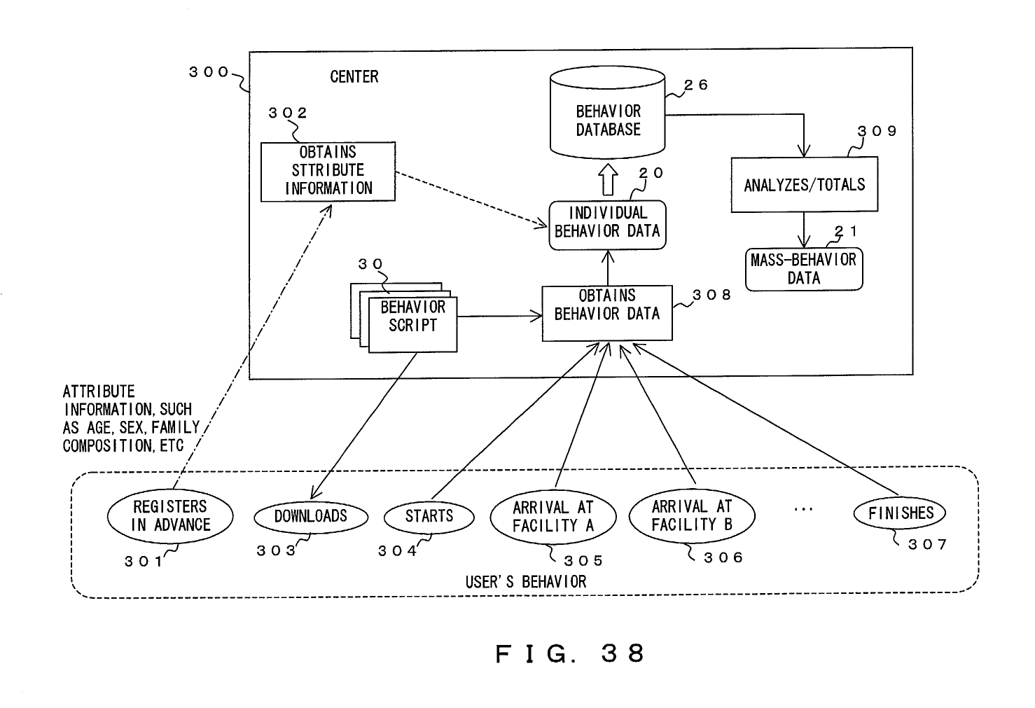

FIG. 38 shows the basic system configuration in the case where the system of the present invention is implemented by collecting individual behavior data in a center.

A user first registers his/her own information (profile) in advance (301). Specifically, a center 300 obtains in advance attribute information, such as the age, sex, family make-up, and etc. (302). Although such a process can be performed every time a behavior script is downloaded, a behavior script 30 can be obtained only by inputting a user ID from the next time once the user is registered in advance. Although such attribute information is not always indispensable, a user can receive individually customized services and serviceability can be improved if such data are inputted in advance. If the name of each user is not inputted due to a privacy problem, the attribute information of each user cannot be obtained. However, since mass behavior taste can be obtained as an aggregate of anonymous behavior data, such data are still useful. If attribute information can be obtained, taste can be categorized and a strategy can be planned for each category. Therefore, in that case, the value of behavior data increases.

If a user wants to actually use a behavior script 30, the user downloads his/her favorite behavior script 30 (303) and starts to execute the behavior script 30 (304). The execution of this behavior script 30 means to download the script 30 into a cellular phone or PDA (Personal Digital Assistant) when walking, or a car navigation system when driving a car and to receive navigation information required to actually take such behavior.

This can be implemented by the method disclosed in the Patent Laid-open No. 2000-215211 “Navigation Information Presenting Device, Navigation Information Presenting Process Method, Storage Medium with Recorded Navigation Information Presenting Program, Storage Medium for Navigation Script, Navigation Script Generation Device, Navigation Operation Management Device using Navigation Script, Method thereof and Program Storage Medium, Travel Time Adjustment Device using Navigation Script, Method thereof and Program Storage Medium, Navigation Plan Generation Device, Method thereof and Program Storage Medium, Navigation Information Provision Device, and Method thereof and Program Storage Medium”.

By using means for inputting a guidance script, including a series of instructions to describe time information and/or place information, guidance information to be outputted depending on a time and/or place to be presented and restriction information about the time information and/or place information based on a prescribed specification, means for obtaining the situations of the current time and/or location or generating the situations of the virtual current time and/or location and means for adjusting time and/or place described in the time information and/or place information using the current time and/or current location obtained by situation acquisition or generation, the time information and/or place information and the restriction information about the time information and/or place information, means for executing the instructions described in the guidance script that is inputted and adjusted depending on the current time and/or current location obtained by situation acquisition or situation generation and means for outputting guidance information to be outputted when the instructions are executed and presenting the information to a user, an appropriate behavior script 30 can be outputted.

Specifically, by adding restriction information about time information and/or place information to a guidance script, an appropriate behavior script 30 can be outputted.

Then, every time the user arrives at each facility, the actual arrival at each facility is reported to the center 300 (305 and 306), and this is repeated until the behavior finishes (307). The center 300 obtains both the behavior script 30 and the facility utilization data from the user (308), generates the individual behavior data 20 and records the data in a behavior database 26. When some amounts of individual behavior data 20 are stored, mass behavior data 21 are generated by analyzing/totaling the behavior database 26 (309).

In this way, the center 300 can check the name of a user who travels, the courses taken by the user and the places actually visited by the user.

For example, behavior data 20 are as follows.

Attribute: male, 30 years old, single, etc.

10:00-10:30 Facility A Has purchased something at some yen.

12:00-13:00 Facility BH as purchased a set lunch.

If behavior data 20 totaled in this way are individually observed, services can be provided based on the personal taste of a user. If the data 20 are totaled and observed as mass behavior data 21, both the combination of places and the visiting order can be obtained as the behavior tendency of a group categorized by a specific attribute.

In this way, the data of behavior patterns collected by the center 300 can be sold to an enterprise that wants to obtain them. The enterprise can effectively use the data for the commodity development and sales strategy. Furthermore, the enterprise can make a strategic plan, such as tie-up sales between enterprises, etc., using the data.

[The Second Preferred Embodiment]

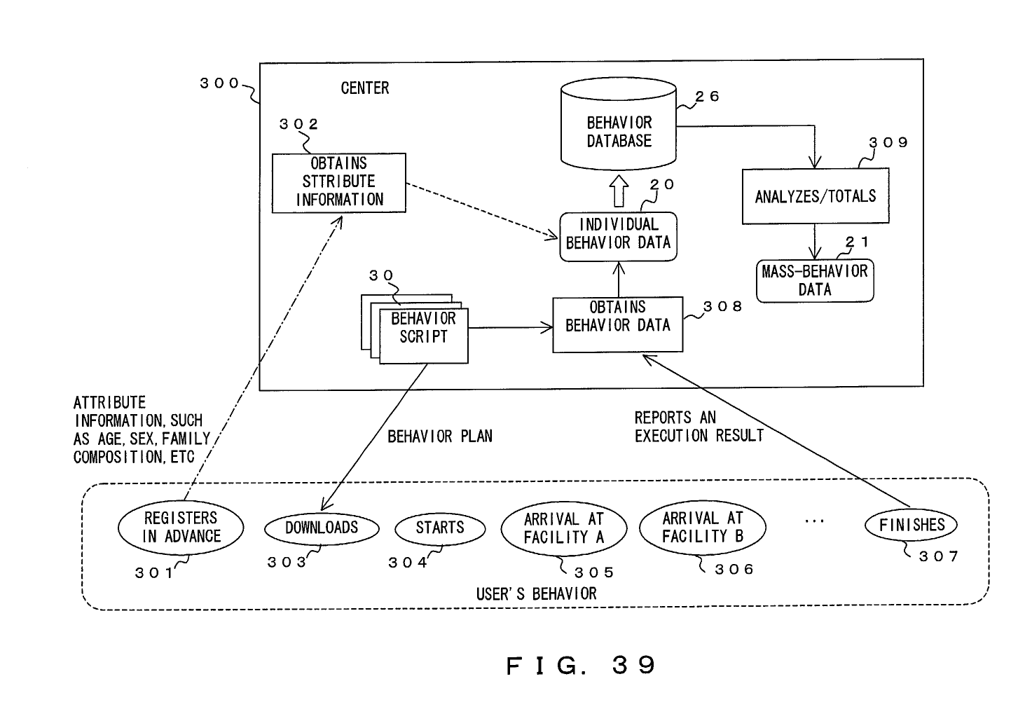

Although the preferred embodiment shown in FIG. 39 is almost the same as the first preferred embodiment, the actual execution result is reported to the center 300 when each piece of behavior in the behavior script 30 is finished (307) although the center 300 is reported every time a user arrives at each facility. If there is no need to process data in real time, this method saves a communications cost and is useful. Since there is no need to transmit the execution result immediately after the process, the terminal of the user can also store the data and can transmit the data of the execution result to the center 300 when the user is connected to the center 300 next time (for example, when downloading a new behavior script later). In this way, the present invention can be used without wireless communications means.

[The Third Preferred Embodiment]

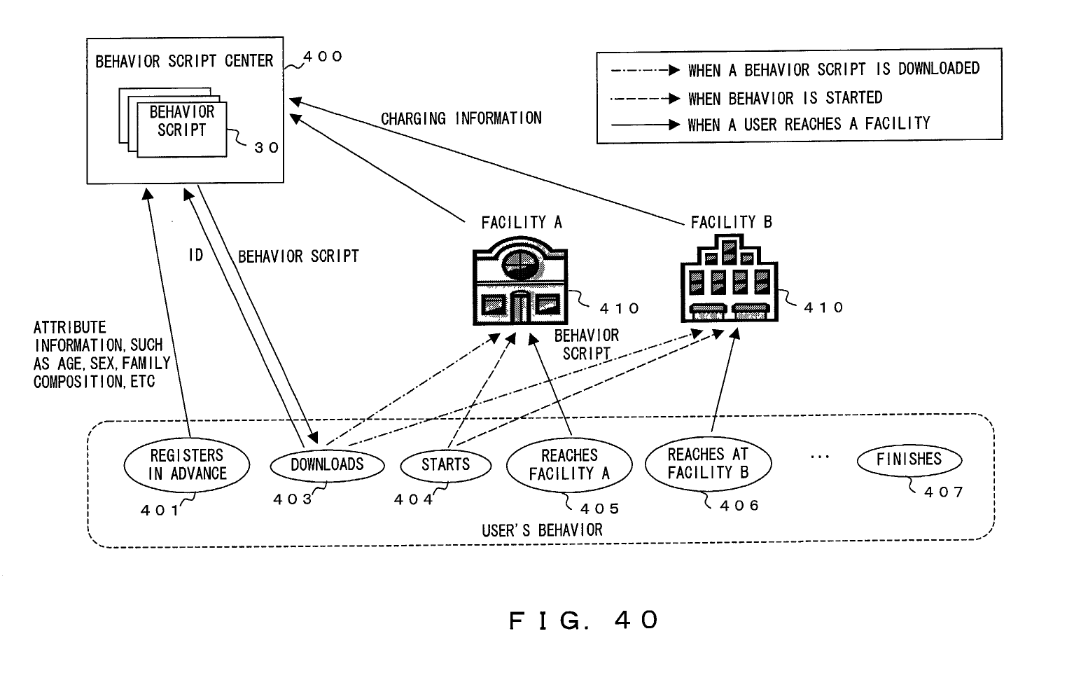

In the configuration shown in FIG. 40, a user is registered in advance (401), a behavior script 30 is downloaded from a behavior center 400 (403) and the behavior script 30 is executed as in the case of the first preferred embodiment. However, the configuration differs from the first preferred embodiment in that the arrival of the user at each facility 410 is reported to each facility 410 when the behavior script 30 is downloaded and when the process of the behavior script is started.

This report to each facility 410 can be implemented by the method disclosed in Japanese Patent Laid-open No. 2000-315293 “Automatic Report System, User Terminal and Server”. According to this method, if report information about both transportation means and facilities to be visited is set in the behavior script 30 on a network and the report information about both the transportation means and facilities to be visited in the behavior script 30 is detected before a travel is executed according to the behavior script 30, reservation information is reported to both the transportation means and facilities to be visited via the network using the report information. Alternatively, when the travel is executed using the behavior script 30, a location or time can be detected and arrival warning or other arrival information can be reported to each facility to be visited at a specific distance from each facility or at a specific time before the arrival.

If in this way, each facility 410 is reported when a behavior script 30 is downloaded, when the process of the behavior script 30 is started and when a user arrives at each facility, each facility 410 pays the fee to the behavior script center 400. Alternatively, when a user reports to each facility, the user can hand over the behavior script 30 to each facility. In this case, the positioning of the user's visit to each facility in the entire behavior plan can be easily understood.

[The Fourth Preferred Embodiment]

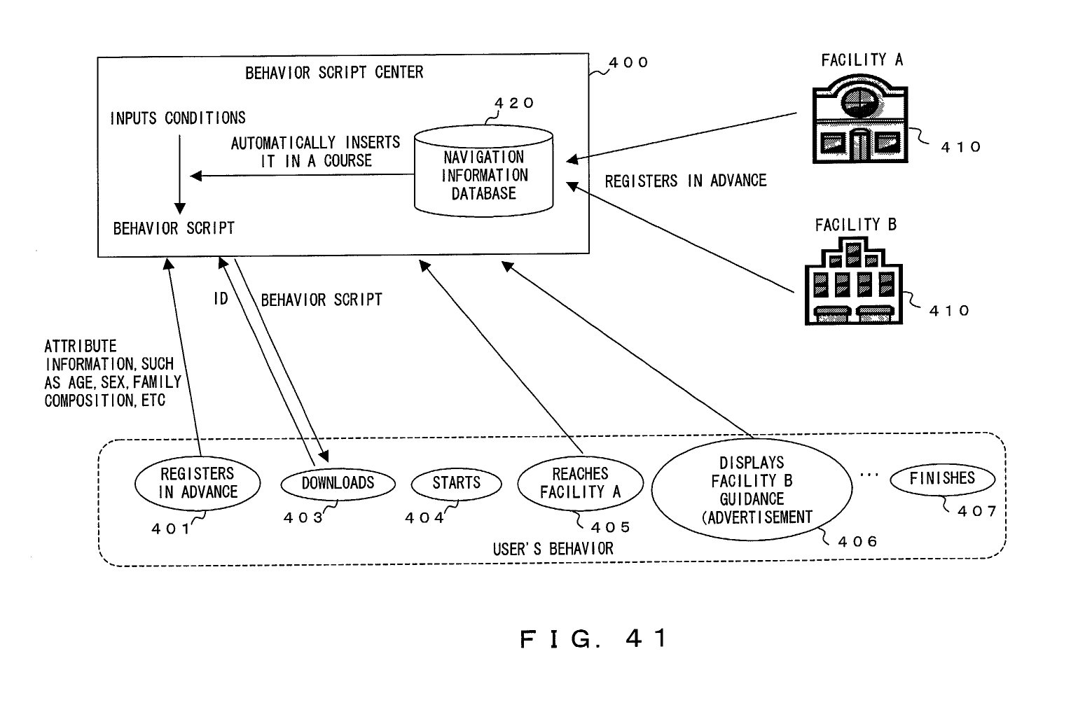

According to the configuration shown in FIG. 41, each facility 410 registers in advance the respective guidance information, advertisement, etc., in the guidance information database 420 of the behavior script center400. On receipt of are quest for a behavior script 30 from a user, the behavior script center 400 extracts both guidance information and advertisement information related to the user's behavior from the guidance information database 420, combines them and provides them to the user.

When a user visits each facility 410 using this behavior script 30 or when advertisement information about each facility 410 is displayed, the fact is reported to the behavior center 400.

In this way, when a user is registered, when guidance information is inserted in a behavior script 30, when a user arrives at each facility 410, or when guidance is presented to a user, the fee is charged.

The automatic generation of a behavior script with guidance information (advertisement) can be implemented by the method disclosed in the Patent Laid-open No.2000-215211 described earlier.

[The Fifth Preferred Embodiment]

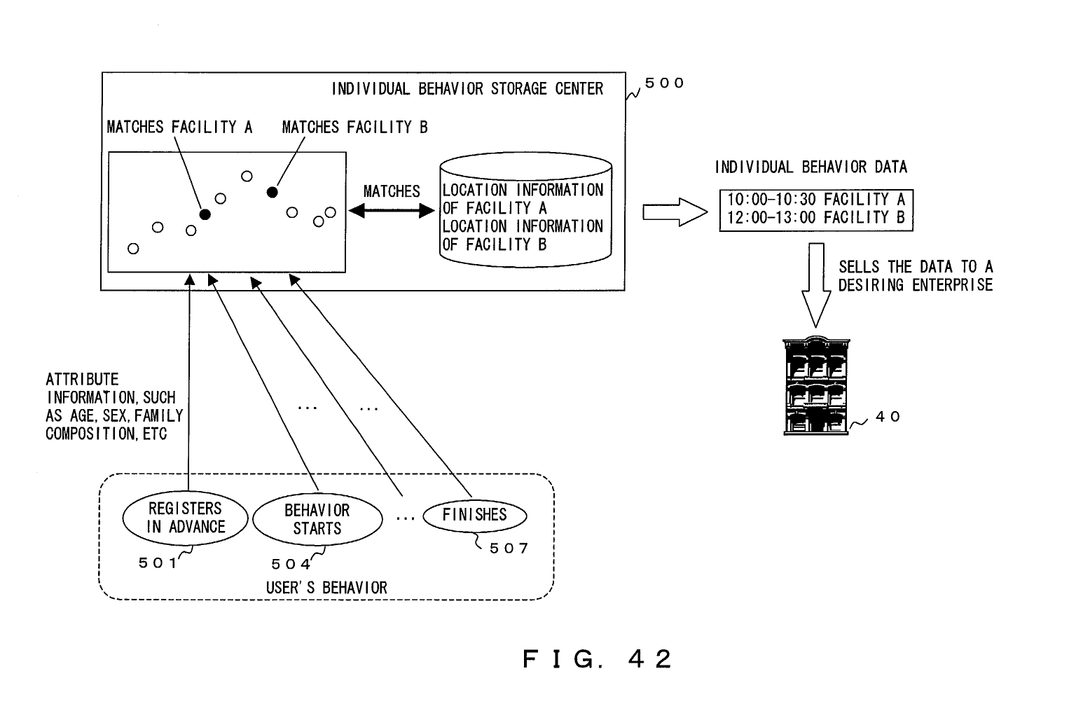

The configuration shown in FIG. 42 comprises no behavior script center used in the third preferred embodiment shown in FIG. 40. In this case, the location information of a user collected in an individual behavior storage center 500 by a location information service, such as a GPS, a PHS (Personal Handyphone System) and the location information of each facility 410 are compared, and the behavior data of the user is generated from matched information. If the data of each facility 410 are POS data, more effective data can be obtained by incorporating them.

[The Sixth Preferred Embodiment]

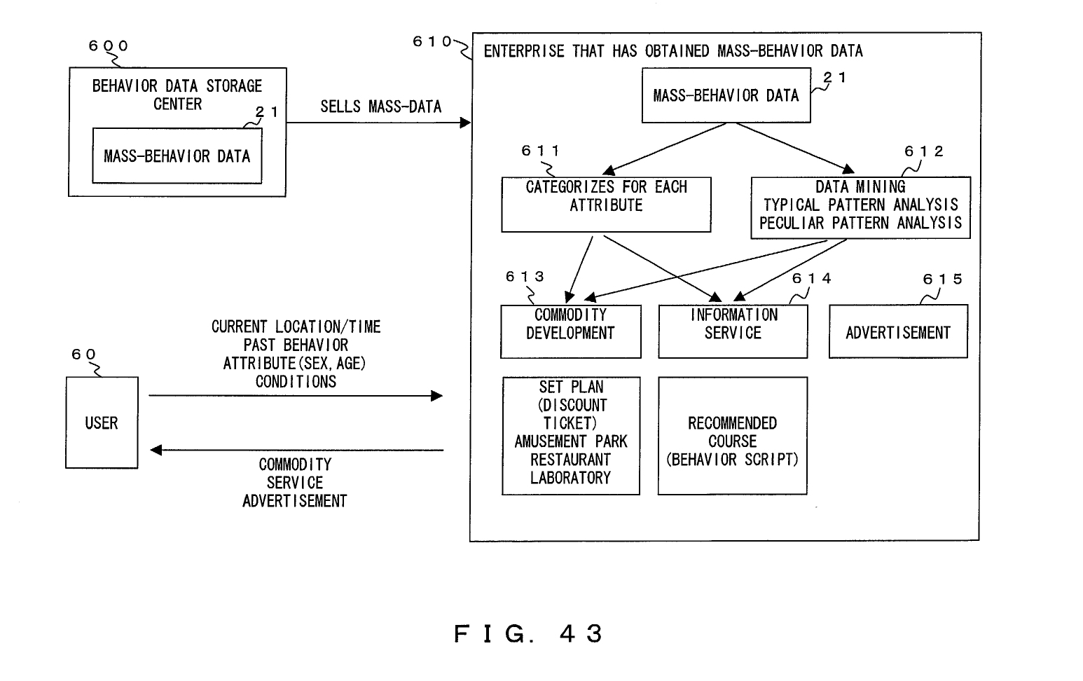

FIG. 43 shows the concept of developing commodities or providing services using mass behavior data 21 obtained by the present invention. In this case, a behavior data storage center 600 sells mass behavior data 21 to enterprises. When an enterprise 610purchases mass behavior data 21, the enterprise 610 categorizes the data for each attribute (611) and analyzes/extracts typical patterns and peculiar patterns by data mining (612). For example, the following behavior patterns are extracted.

Many women in forties with attribute G dine in Tsukiji after shopping in Ginza.

30% of people rides on the Ferris wheel of Pallet Town and dines at Venus Photo.

The enterprise 610 generates and sells a discount ticket in which a ticket for the Ferris wheel and a meal ticket for Venus Photo are set (613), puts discount tickets of meal at Venus Photo in the Ferris wheel or puts an advertisement on the Ferris wheel (615). The enterprise 610 generates a behavior script for riding on the Ferris wheel of Pallet Town and dining at Venus Photo, provides the information as a popular and recommendable course or sells the data (614).

[The Seventh Preferred Embodiment]

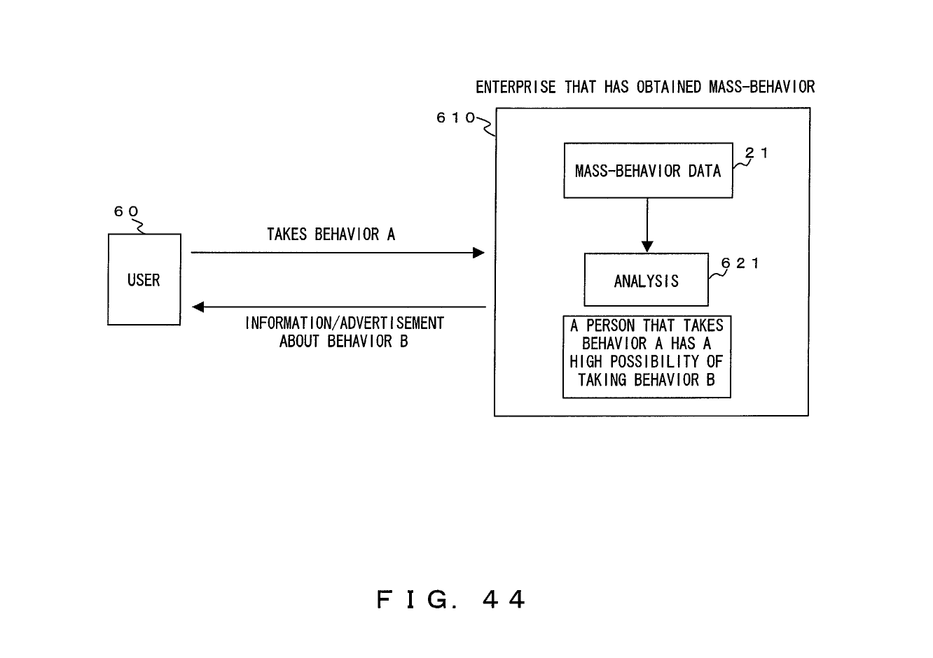

FIG. 44 shows the concept of a system in which an enterprise 610 that has obtained mass behavior data by the present invention analyzes the mass behavior data 21 and recommends recommendable behavior to a user 60.

If the enterprise 610 that has obtained mass behavior data 21 extracts a behavior pattern that “a person that takes behavior A has a high possibility of taking behavior B”, the enterprises 610 provides information about commodities (services) related to the behavior B or advertises the commodities when a specific user takes behavior A. In this way, the user's possibility of purchasing such commodities increases.

When in addition, both attribute information and situations are taken into consideration, the accuracy further increases. In this way, for example, a behavior plan (destination, etc.) can be recommended by obtaining the location of a user using a location information service, such as a GPS, a PHS, etc., calling up the attribute of the user from data registered in advance, combining the attribute with information obtained by a variety of other sensors, etc., such as time, day in a week, season, climate, etc., detecting similar data from the data extracted from stored behavior data or mass behavior data. Such a service can be transmitted as requested or can be positively transmitted depending on the situation of the user. Compared with unilateral information service, such as direct mail, such a service has a high possibility of providing information desired by a user.

As one detailed preferred embodiment of the present invention, a case where a behavior script is described in a guidance language NVML (Navigation Markup Language) similar to XML (extensible Markup Language) is described below.

If, for example, in the system shown in FIG. 22 or 23, a user transmits the current location, which is the staring point of a route to be taken, a destination/route to be taken from now on and a request for information, the behavior data fee collection system 100 at the center searches for information suitable for the user's request, such as congestion information, event/restriction information, parking lot information, sectional travel time information, climate information, sightseeing information, etc., and transmits the information to the user.

For example, if a user transmits information about one location and makes are quest for both a parking lot and climate information, the data format is as shown in example 1.

### EXAMPLE 1

### Data Request Format (NVML Used)

<?xml version=“1.0” encoding=“Shift-JIS”?>
<!DOCTYPE nvml SYSTEM “nvml-00-06-00.dtd”>
<nvml version=“0.60”>

<head>

<title>REQUEST SAMPLE</title>
<category>REQUEST</category>
<note name=“ID” content=“ID-12345”/>
<note name=“REQUEST” content=“parking lot

information”/>

<note name=“REQUEST” content=“weather forecast”

/>

</head>
<body>

<guide>

<point area=“2km”>

<name>Tokyo station</name>
<latitude>N35. 40. 38. 281</latitude>
<longitude>E139. 46. 19. 804</longitude>

</point>

</guide>

</body>

</nvml>

The following example 2 is an example of the data format of a request to transmit route information from Tokyo station to Ueno station and to obtain both parking lot information and town information.

### EXAMPLE 2

### Data Request Format(NVML Used)

<?xml version=“1.0” encoding=“Shift-JIS”?>
<!DOCTYPE nvml SYSTEM “nvml-00-06-00.dtd”>
<nvml version=“0.60”>

<head>

<title>REQUEST SAMPLE</title>
<category>REQUEST</category>
<note name=“ID” content=“ID-12345”/>
<note name=“REQUEST” content=“parking lot

information“/>

<note name=“REQUEST” content=“town

information“/>

<note name=“area” content=“2km”/>

</head>
<body>

<navi>

<point>

<name>Tokyo station</name>
<latitude>N35. 40. 38. 281</latitude>
<longitude>E139. 46. 19. 804</longitude>

</point>

</navi>
<navi>

<point>

<latitude>N35. 40. 48. 906</latitude>
<longitude>E139. 46. 26. 660</longitude>

</point>

</navi>
<navi>

<point>

<latitude>N35. 40. 53. 281</latitude>
<longitude>E139. 46. 8. 203</longitude>

</point>

</navi>
<navi>

<point>

<latitude>N35. 41. 20. 468</latitude>
<longitude>E139. 46. 14. 3</longitude>

</point>

</navi>
<navi>

<point>

<latitude>N35. 41. 34. 843</latitude>
<longitude>E139. 46. 14. 3</longitude>

</point >

</navi>
<navi>

<point>

<latitude>N35. 41. 43. 906</latitude>
<longitude>E139. 46. 19. 628</longitude>

</point>

</navi>
<navi>

<point>

<latitude>N35. 41. 59. 531</latitude>
<longitude>E139. 46. 22. 265</longitude>

</point>

</navi>
<navi>

<point>

<latitude>N35. 42. 18. 125</latitude>
<longitude>E139. 46. 23. 144</longitude>

</point>

</navi>
<navi>

<point>

<latitude>N35. 42. 16. 250</latitude>
<longitude>E139. 46. 45. 292</longitude>

</point>

</navi>
<navi>

<point>

<latitude>N35. 42. 29. 687</latitude>
<longitude>E139. 46. 47. 226</longitude>

</point>

</navi>
<navi>

<point>

<name>Ueno station</name>
<latitude>N35. 42. 33. 125</latitude>
<longitude>E139. 46. 52. 675</longitude>

</point >

</navi>

</body>

</nvml>

An example of behavior script retrieved by the system and transmitted to a user is shown below.

Example 3 shows the case where congestion information is returned by a behavior script 30.

### EXAMPLE 3

<?xml version=“1.0” encoding=“Shift-JIS”?>
<!DOCTYPE nvml SYSTEM “nvml-00-06-00.dtd”>
<nvml version=“0.60”>

<head>

<title>DATA SAMPLE</title>
<category>congestion information</category>
<note name=“presentation time” content=“10

o'clock 45 minutes”/>

<note name= “effective time“ content=”15

minutes”/>

<note name=“version” content=“1.0”/>

</head>
<body>

<navi>

<point>

<name>Tokyo station</name>
<latitude>N35. 40. 38. 281</latitude>
<longitude>E139. 46. 19. 804</longitude>

</point>

</navi>
<navi>

<route>

<means>car</means>

</route>
<info>

<note name=“congestion degree” content=“3 ”/>

</info>

</navi>
<navi>

<point>

<latitude>N35. 40. 48. 906</latitllde>
<longitude>E139. 46. 26. 660 </longitude>

</point>

</navi>
<navi>

<route>

<means>car</means>

</route>
<info>

<note name=“congestion degree” content=“ 3 ”

/>

</info>

</navi>
<navi>

<point>

<latitude>N35. 40. 53. 281</latitude>
<longitude>E139. 46. 8. 203</longitude>

</point>

</navi>
<navi>

<route>

<means>car</means>

</route>
<Info>

<note name=“congestion degree” content=“

3”/>

</info>

</navi>
<navi>

<point>

<latitude>N35. 41. 20. 468</latitude>
<longitude>E139. 46. 14. 3</longitude>

</point>

</navi>
<navi>

<route>

<means>car</means>

</route>
<info>

<note name=“congestion degree” content=“

3”/>

</info>

</navi>
<navi>

<point>

<latitude>N35. 41. 34. 843</latitude>
<longitude>E139. 46. 14. 3</longitude>

</point>

</navi>
<navi>

<route>

<means>car</means >

</route>
<info>

<note name=“congestion degree” content=“

3”/>

/info>

</navi>
<navi>

<point>

<latitude>N35. 41. 43. 906</latitude>
<longitude>E139. 46. 19. 628</longitude>

</point>

</navi>
<navi>

<route>

<means>car</mean>

</route>
<info>
<note name=“congestion” content=“3”/>
</info>

</navi>
<navi>

<point>

<latitude>N35. 41. 59. 531</latitude>
<longitude>E139. 46. 22. 265</longitude>

</point>

</navi>
<navi>

<route>

<means>car</means>

</route>
<info>

<note name=“congestion degree” content=“ 3”/>

</info>

</navi>
<navi>

<point>

<latitude>N35. 42. 18. 125</latitude>
<longitude>E139. 46. 23. 144</longitude>

</point>

</navi>
<navi>

<route>

<means>car</means>

</route>
<info>

<note name =“congestion degree” content=“3”/>

</info>

</navi>
<navi>

<point>

<latitude>N35. 42. 16. 250</latitude>
<longitude>E139. 46. 45. 292</longitude>

</point>

</navi>
<navi>

<route>

<means>car</means >

</route>
<info>

<note name=“congestion degree” content=“3”/>

</info>

</navi>
<navi>

<point>

<latitude>N35. 42. 29. 687</latitude>
<longitude>E139. 46. 47. 226</longitude>

</point>

</navi>
<navi>

<route>

<means>car</means>

</route>
<info>

<note name=“congestion degree” content=“3”/>

</info>

</navi>
<navi>

<point>

<name>Ueno station</name>
<latitude>N35. 42. 33. 125</latitude>
<longitude>E139. 46. 52. 675</longitude>

</point>

</navi>

</body>

</nvml>

The following example 4 shows the case where even/restriction information is returned by a behavior script 30.

### EXAMPLE 4

<?xml version=“1.0” encoding= “Shift-JIS”?>
<!DOCTYPE nvml SYSTEM “nvml-00-06-00.dtd”>
<nvml version=“0.60”>

<head>

<title>DATA SAMPLE</title>
<category>event/restriction

information</category>

<note name=“restriction start” content=“9 o'clock,

June 23, 2000”/>

<note name=“restriction finish” content=“9

o'clock, June 23, 2000” />

<note name=“restriction condition” content=“

period in time range”/>

<note name=“cause” content=“accident”/>
<note name=“cause detail” content=“car

accident”/>

<note name=“restriction” content=“all traffic

prohibited”/>

<note name=“restriction detail” content=“all

enter prohibited”/>

<note name=“mark” content=“9432”/>
<note name=“video” content=“movie.mov”/>
<note name=“audio” content=“voice.avi”/>

</head>
<body>

<navi>

<point>

<name>Tokyo station</name>
<latitude>N35. 40. 38. 281</latitude>
<longitude>E139. 46. 19. 804</longitude>

</point>
<info>

<text>all car traffic is prohibited due to car

accident from Tokyo station to Ueno station from 9
o'clock, June 23, 2000 till 17 o'clock, June 23,
2000</text>

<image src=“tokyo-image.jpg”/>
<note name=“place” content=“ starting point”/>
</info>

</navi>
<navi>

<route>

<means>car</means>

</route>

</navi>
<navi>

<point>

<latitude>N35. 40. 48. 906 </latitudi>
<longitude>E139. 46. 26. 660</longitude>

</point>
<info>

<note name=“place” content=“passing point”/>

</info>

</navi>
<navi>

<point>

<latitude>N35. 40. 53. 281 </latitude>
<longitude>E139. 46. 8. 203 </longitude>

</point>
<info>

<note name=“place” content=“passing point”/>

</info>

</navi>
<navi>

<point>

<latitude>N35. 41. 20. 468</latitude>
<longitude>E139. 46. 14. 3</longitude>

</point>
<info>

<note name=“place” content=“ passing point”/>

</info>

</navi>
<navi>

<point>

<latitude>N35. 41. 34. 843</latitude>
<longitude>E139. 46. 14. 3</longitude>

</point>
<info>

<note name=“place” content=“passing point”/>

</info>

</navi>
<navi>

<point>

<latitude>N35. 41. 43. 906</latitude>
<longitude>E139. 46. 19. 628</longitude>

</point>
<info>

<note name=“place” content=“passing point”/>

</info>

</navi>
<navi>

<point>

<latitude>N35. 41. 59. 531</latitude>
<longitude>E139. 46. 22. 265</longitude>

</point>
<info>

<note name=“place” content=“passing point”/>

</info>

</navi>
<navi>

<point>

<latitude>N35. 4.2. 18. 125</latitude>
<longitude>E139. 46. 23. 144</longitude>

</point>
<info>

<note name=“place” content=“passing point”/>

</info>

</navi>
<navi>

<point>

<latitude>N35. 42. 16. 250</latitude>
<longitude>E139. 46. 45. 292</longitude>

</point>
<info>

<note name=“place” content=“passing point”/>

</info>

</navi>
<navi>

<point>

<latitude>N35. 42. 29. 687</latitude>
<longitude>E139. 46. 47. 226</longitude>

</point>
<info>

<note name=“place” content=“passing point”/>

</info>

</navi>
<navi>

<point>

<name>Ueno station</name>
<latitude>N35. 42. 33. 125</latitude>
<longitude>E139. 46. 52. 675</longitude>

</point>
<info>

<image src=“ueno-image.jpg”/>
<note name=“place” content=“finishing

point”/>

</info>

</navi>

</body>

</nvml>

The following example 5 shows the case where parking lot information is returned by a behavior script 30.

### EXAMPLE 5

<?xml version=“1.0” encoding=“Shift-JIS”?>
<!DOCTYPE nvml SYSTEM “nvml-00-06-00.dtd”>
<nvml version=“0.60”>

<head>

<title>DATA SAMPLE</title>
<category>parking lot information</category>

</head>
<body>

<guide>

<point area=“500m”>

<name>Shinjuku 1-chome PA</name>
<category>public parking lot</category>
<latitude>N35. 41. 8. 671</latitude>
<longitude>E139. 42. 56. 863</longitude>
<address>1-1, Shinjuku 1-chome, Shinjuku-ku,

Tokyo</address>

<phone>03-3111-1111</phone>

</point>
<info>

<text>You are now requested to wait for half

an hour. Please use another parking lot.</text>

<voice>You are now requested to wait for half

an hour. Please use another parking lot</voice>

<image src=“shinjyuku-parking-01.jpg”/>
<note name=“occupied/vacant” content=“fully

occupied”/>

<note name=“occupation ratio” content=“80% ”

/>

<note name=“waiting time” content =“half an

hour”/>

<note name=“number of cars to be accommodated”

content=“150 cars”/>

<note name=“height limit” content=“4m”/>
<note name=“model restriction” content=“up to

3-digits cars”/>

<note name=“discount condition” content=“

free of charge for 2 hours if commodities equivalent
to or more than 3,000 yen are bought in this department
store”/ >

<note name=“fee” content=“500 yen for the

first hour and 200 yen for each 20 minutes after that”/>

<note name=“open” content=“9-20 o'clock”/>

</info>

</guide>
<guide>

<point area=“500m”>

<name>Shinjyku 2-chome PA</name>
<category>public parking lot</category>
<latitude >N35. 41. 14. 609</latitude>
<longitude>E139. 42. 42. 625</longitude>
<address>1-1, Shinjuku 2-chome, Shinjuku-ku,

Tokyo</address>

<phone>03-3111-2222</phone>

</point>
<info>

<text>There is vacancy. Please use our parking

lot. </text>

<voice>There is vacancy. Please use our

parking lot.</voice>

<imge src=“sinjukuku-parking-02.jpg”/>
<note name=“occupied/vacant”

content=“vacant”/>

<note name =“occupation ratio”

content=“60%”/>

<note name= waiting time” content=“zero”/>
<note name=“number of cars to be accommodated”

content=“100 cars” />

<note name=“height limit” content=“4m”/>
<note name=“model restriction” content=“up

to 3-digits cars”/ >

<note name=“discount condition”

content=“free of charge for one hour if commodities
equivalent to or more than 3000 yen are bought in this
department store”/>

<note name=“fee” content=“500 yen for the

first hour and 200 yen for each 20 minutes after that”/>

<note name=“open” content=“24 hours”/>

</info>

</guide>

</body>

</nvml>

The following example 6 shows the case where sectional travel time information is returned by a behavior script 30.

### Example 6

<?xml version=“1.0” encoding=“Shift-JIS”?>
<!DOCTYPE nvml SYSTEM “nvnl-00-06-00.dtd”>
<nvml version=“0.60”>

<head>

<title>DATA SAWLE</title>
<category>sectional travel time

information</category>

<duration>40 minutes</duration>
<note name=“priority” content=“1”/>

</head>
<body>

<navi>

<point>

<name>Tokyo station</name>
<latitude>N35. 40. 38. 281</latitude>
<longitude>E139. 46. 19. 804 </longitude>

</point>
<info>

<image src=“tokyo-image.jpg”/>
<note name=“place” content=“starting point”/>

</info>

</navi>
<navi>

<route>

<means>car</means >

</route>

</navi>
<navi>

<point>

<latitude>N35. 40. 48. 906</latitude>
<longitude>E139. 46. 26. 660</longitude>

</point>
<info>

<note name=“place” content=“passing point”/>

</info>

</navi>
<navi>

<point>
<latitude>N35. 40. 53. 281</latitude>
<longitud>E139. 46. 8. 203</longitude>
</point>
<info>

<note name=“place” content=“passing point”/>

</info>

</navi>
<navi>

<point>

<latitude>N35. 41. 20. 468</latitude>
<longitude>E139. 46. 14. 3</longitude>

</point>
<info>

<note name=“place” content=“passing point”/>

</info>

</navi>
<navi>

<point>

<latitude>N35. 41. 34. 843</latitude>
<longitude>E139. 46. 14. 3</longitude>

</point>
<info>

<note name=“place” content=“passing point”/>

</info>

</navi>
<navi>

<point>

<latitude>N35. 41. 43. 906</latitude>
<longitude>E139. 46. 19. 628</longitude>

</point>
<info>

<note name=“place” content=“passing

point”/>

</info>

</navi>
<navi>

<point>

<latitude>N35. 41. 59. 531</latitude>
<longitude>E139. 46. 22. 265</longitude>

</point>
<info>

<note name=“place” content=“passing point”/>

</info>

</navi>
<navi>

<point>

<latitude>N35. 42. 18. 125</latitude>
<longitude>E139. 46. 23. 144</longitude>

</point>
<info>

<note name=“place” content=“passing point”/>

</info>

</navi>
<navi>

<point>

<latitude>N35. 42. 16. 250</latitude>
<longitude>E139. 46. 45. 292</longitude>

</point>
<info>

<note name =“place” content=“passing point”/>

</info>

</navi>
<navi>

<point>

<latitude>N35. 42. 29. 687</latitude>
<longitude>E139. 46. 47. 226</longitude>

</point>
<info>

<note name=“place” content=“passing point”/>

</info>

</navi>
<navi>

<point>

<name> Ueno station</name>
<latitude>N35. 42. 33. 125</latittlde>
<longitude>E139. 46. 52. 675</longitude>

</point>
<info>

<image src=“ueno-image.jpg”/>
<note name=“place” content=“finishing

point”/>

</info>

</navi>

</body>

</nvml>

The following example 7 shows the case where congestion information, event/restriction information, parking lot information, sectional travel time information, climate information, sightseeing information are collectively returned by a behavior script 30 using another data format.

### Example 7

<∘∘ml version=“x.x”>

<header>

<geodetic-system>Japan

geodetic-system</geodetic-system>

<presentation-time>10 o’clock 45 minutes, July 1,

2000</presentation-time>

<effective-time>15 minutes</effective-time>
<update>2000-01</update>

</header>
<congestion-information>

<road type=“urban highway”/>
<location type=“starting-point”

latitude=“N35.40.38.281”
longitude=“E139.46.19.804.”/>

<location type=“finishing-point”

latitude=“N35.40.37.281” longitude=“E139.47.19.804
=/>

<congestion-data congestion-degree=“congestion”

congestion-length=“500 m”
time-required-to-pass=“120s” time
type=“estimated”/>

<!-- congestion length can be omitted since

congestion length can be calculated from latitude-->

<video src=“jam01.mov”/><!--congestion picture

in the neighborhood of the location-->

<image level=“2” src=“jam01.jpg”/><!-congestion

picture or picture equivalent to level 2>

<text>congested from Shibuya intersection due to

heavy traffic /text>

</congestion-information>
<congestion-information>

<road type=“urban highway”/>
<location type=“starting point”

latitude=“N35.40.37.281”
longitude=“E139.47.19.804”/>

<location type=“finishing point”

latitude=“N35.40.36.281”
longitude=“E139.47.18.804”/>

<congestion-data congestion-degree=“heavy

traffic” congestion-length=“200 m”/>

</congestion-information>
<congestion-information>

<location type=“starting-point”

latitude=“N35.40.36.281”
longitude=“E139.47.16.804”/>

<location type=“finishing-point

latitude=“N35.40.35.351”
longitude=“E139.47.16.004”/>

<congestion-data congestion-degree=“no

congestion”/>

</congestion-information>
<congestion-information>

<road type=“public-road”/>
<location type=“starting-point”

latitude=“N35.40.35.351”
longitude=“E139.47.16.004”/>

<location type=“passing-point”

latitude=“N35.40.33.300” longitude=“E139.45.18.035
”/>

<location type=“passing-point”

latitude=“N35.40.32.100”
longitude=“E139.44.34.035”/>

<location type=“finishing-point”

latitude=“N35.40.30.300”
longitude=“E139.43.20.038”/>

<congestion-data congestion-degree=“unknown”/>

</congestion-information>
<event-restriction>

<cause type=“accident” occurrence time=“8 o’clock

30 minutes, June 23, 2000” <collision of 2 large
trucks</cause>

<!--details are described in content section-->
<test>2 trucks colide at about 8 o’clock 30 minutes,

June 23,2000. All traffic is prohibited from Setagaya
to Nerima 1-chome.</text>

<road type=“urban highway”/>
<location type =“starting-point

latitude=“N35.40.35.351”
longitude=“E139.47.16.004” area name=“ Setagaya”/>

<location type=“finishing-point”

latitude=“N35.41.33.331”
longitude=“E139.46.23.004” area-name=“Nerima
1-chome”/>

<location type=“passing point”

latitude=“N35.40.34.301”
longitude=“E139.45.18.004” area-name=“Setagaya
2-chome”/>

<voice src=“voice.avi”/>
<video src=“movie.mov”/>
<image src=“picture.jpg”/>
<restriction>
<content>all car traffic prohibited </content>
<time start=“9o’clock, June 23, 2000” finish=“17

o’clock, June 23, 2000”/>

<condition>time zone during period </condition>

</restriction>
</event-restriction-information>
<event-restriction-information>
.
.
.
</event-restriction-information>
.
.
.
<parking-lot-information>
name type=“public parking lot”>Shinjuku

PA</name>

<road type=“public road”/>
<location latitude=“N35.41.38.301

” longitude=“E139.45. 18.004” area name=“Shinjuku
1-chome”/>

<state occupation-ratio=“90%” waiting-time=” 30

minutes”/>

<facility-summary>

<number-of-cars-to-be-accommodated>

150</number-of-cars-to-be-accommodated>

<car-restriction height=“4 m” width=“5 m”

length=“6 m” weight=“2000 kg” type=“large”/>

<fee>500 yen for the first hour and 200 yen for

each 20 minutes after that </fee>

<discount-confition>free of charge for one hour

if commodities equivalent to 2,000 yen are bought in
∘∘department store</discount-condition>

<open>9-20 o’clock</open>
<holiday>every Tuesday</holiday>

</facility-summary>

</parking-lot-information>
<parking-lot-information>
.
.
.
</parking-lot-information>
.
.
.
</sectional-travel-time-information>

<required-time priority=“1”>40

minutes</required-time>

<road type=“urban highway”/>
<location type=“starting-point”

latitude=“N35.41.38.301”
longitude=“E139.45.18.004” area-name=“Aoyama
1-chome”/>

<location type=“finishing-point”

latitude=“N35.42.38.301”
longitude=“E139.44.18.004” area-name=“Aoyama
2-chome”/>

<locaiton type=“passing-point”

latitude=“N35.43.38.301
longitude=“E1329.43.18.004” area-name=“Aoyama
3-chome”/>

</sectional-travel-time-information>
<sectional-travel-time-information>
.
.
.
</sectional-travel-time-information>
.
.
.
<climate-information>

<locaiton latitude=“N35.40.38.301”

longitude=“E139.42.18.004” area-name=“Shibuya-ku”
range=“5 km”/>

<day-and-time>

<start>9 o’clock, July 4, 2000></start>
<finish>12 o’clock, July 4, 2000></finish>

</day-and-time>
<forecast type=“3-hours forecast”>

<temperature minimum=“22° C.” maximum=“30° C.”/>
<humidity>60%</humidity>
<weather>cloudy and later clear</weather>
<rainfall-probability>15%</rainfall-

probability>

</forecast>

<climate-information>
<sightseeing-information>

<lcoation latitude=“N35.40.38.301”

longitude=“E139.42.18.004” area-name=“Shibuya”

<event name=“Shibuya festival”

<video src=“vent.mov”>
<image src=“event.jpg”/>
<text>Shibuya festival is held from 18 o’clock.

July 4, 2000.</text>

</event>

</locaiton>

</sightseeing-information>

<∘∘ ml>

For the detailed language specification, etc., of guidance script language (NVML) in the examples 1-6 described above, see the Patent Laid-open No.2000-215211. This guidance script language is very easy to understand and very easy to decode without the detailed language specification. Therefore, the description of the detailed content in each example is omitted here. Example 7 is also easy to decode.

A program for enabling a computer implement the systems described above can be stored in an appropriate storage medium, such as a computer-readable portable medium memory, a semi-conductor memory, a hard disk, etc.

As described above, the present invention has the following effects.

(1) By providing a mechanism for trading behavior data, behavior data can be effectively utilized as follows.

Consideration of intermediate behavior until reaching a facility, a destination after reaching the facility, etc., can be useful to plan a future customer strategy.

Commodities suitable for a series of behavior can be developed.

The subsequent behavior of a user can be estimated to some degree and advertisement can be made based on the estimation. Therefore, the cost performance of advertisement can be improved.

Since user behavior continuity can also be used as key data when datamining.

The obtained travel patterns of human being are useful for town development, such as a traffic network, etc., a traffic regulations, etc.

(2) The followings can be implemented by the provision of charging means from facilities included a behavior script.

The provider of a behavior script can obtain compensation from facilities by the distribution of a behavior script.

Since a fee can be paid only when guidance data are actually used, fair charging is made possible. Therefore, there is no loss for both the paying and collecting sides of a fee, and both the payment and collection are made very efficient.

Since a facility is charged when a user actually visit it, there is no need for wasteful advertisement.

Facilities are provided with a new advertisement means.

By using behavior data described in a behavior script language according to a prescribed language specification, the collection/utilization of behavior data for a general purpose can be easily implemented.

What is claimed is:

1. A behavior data fee collection system using a computer, comprising:
a behavior acquisition unit obtaining behavior data about a series of human behavior;
a behavior data recording/storage unit recording and storing obtained behavior data; and
a data sale unit selling recorded and stored behavior data.

2. A behavior data fee collection system using a computer, comprising:
a behavior acquisition unit obtaining behavior data about a series of human behavior;
a behavior data recording/storage unit recording and storing obtained individual behavior data;
a mass behavior data generation unit analyzing recorded and stored behavior data and generating statistically processed mass behavior data; and
a data sale unit selling generated mass behavior data.

3. A behavior data fee collection system using a computer, comprising:
a data process unit processing data in which a paired series of at least place information and information about the place, provided to a user are described according to a prescribed specification; and
a fee collection unit collecting a fee from a facility included in the place information described in the data.

4. A behavior data fee collection system using a computer, comprising:
a data process unit processing data in which a paired series of at least place information and information about the place, provided to a user are described according to a prescribed specification;
a place data acquisition unit obtaining place data transmitted from the unit;
a behavior data generation unit totaling information from obtained place data as behavior data; and
a behavior data fee calculation unit calculating a fee of the behavior data.

5. A behavior data fee collection system using a computer, comprising:
a facility data registration unit registering facility data;
a registration fee calculation unit calculating a registration fee when the data are registered; and
a behavior data generation unit generating data in which a paired series of at least place information and information about the place, provided to a user are described according to a prescribed specification, using registered facility data.

6. A behavior data fee collection system using a computer, comprising:
a facility data registration unit registering facility data;
a behavior data generation unit generating data in which a paired series of at least place information and information about the place, provided to a user are described according to a prescribed specification, using registered facility data;
a behavior data process unit obtaining information about use of data when the data are generated; and
a charging unit charging a fee against each facility at the time.

7. A behavior data fee collection system using a computer, comprising:
a facility data registration unit registering facility data;
a behavior data generation unit generating data in which a paired series of at least place information and information about the place, provided to a user are described according to a prescribed specification, using registered facility data;
a behavior data process unit obtaining information about use of data when the data are downloaded, when use of the data is started, when each facility is reported in a process of the data or when guidance or advertisement on each facility is presented to a user in a process of the data; and
a charging unit charging a fee against each facility at the time.

8. A behavior data fee collection system using a computer, comprising:
a user situation acquisition unit obtaining a location or route of a user;
an information provision unit providing information depending on the obtained location and route; and
a charging unit charging when providing the information.

9.A behavior data fee collection system using a computer, comprising:
a facility data registration unit registering facility data;
a behavior data generation unit generating data in which a paired series of at least place information and information about the place, provided to a user are described according to a prescribed specification, using registered facility data;
a user situation acquisition unit obtaining a location and route of a user;
a judgment unit judging relationship between the data and an actual location or route of a user;
a behavior data process unit obtaining information about use of data when the data related to a location or route are downloaded, when use of the data is started or when each facility is reported in a process of the data; and
a charging unit charging a fee against each facility at the time.

10. A behavior data fee collection system using a computer, comprising:
a facility data registration unit registering facility data;
a travel data acquisition unit obtaining travel data of a user;
a judgment unit judging whether location data included in the facility data match actual travel data of a user;
a behavior data generation unit generating behavior data of a user based on a judgment result; and
a behavior data fee calculation unit calculating a fee of the behavior data.

11. A behavior data fee collection system using a computer, comprising:
a facility data registration unit registering facility data;
a facility data acquisition unit obtaining facility utilization data of a user;
a judgment unit judging whether the facility data match the facility utilization data of a user;
a behavior data generation unit generating behavior data of a user based on a judgment result; and
a behavior data fee calculation unit calculating a fee of the behavior data.

12. A behavior data fee collection system using a computer, comprising:
a behavior data acquisition unit obtaining behavior data about a series of human behavior; and
an information provision/advertisement unit detecting a combination of a plurality of pieces of behavior frequently made from obtained behavior data and providing information about or advertising the same behavior combination when a user takes one of the plurality of pieces of behavior.

13. A behavior data fee collection system using a computer, comprising:
a behavior data acquisition unit obtaining behavior data about a series of human behavior; and
a proposal unit categorizing obtained behavior data for each user attribute and proposing a destination suitable for an attribute when requested by a user with the attribute.

14. A behavior data fee collection method using a computer, comprising:
obtaining behavior data about a series of human behavior;
recording and storing obtained behavior data; and
selling recorded and stored behavior data.

15. A behavior data fee collection method using a computer, comprising:
obtaining behavior data about a series of human behavior;
recording and storing obtained individual behavior data;
analyzing recorded and stored behavior data and generating statistically processed mass behavior data; and
selling generated mass behavior data.

16. A behavior data fee collection method using a computer, comprising:
processing data in which a paired series of at least place information and information about the place, provided to a user are described according to a prescribed specification; and
collecting a fee from a facility included in the place information described in the data.

17. A behavior data fee collection method using a computer, comprising:
processing data in which a paired series of at least place information and information about the place, provided to a user are described according to a prescribed specification;
obtaining place data transmitted from the unit;
totaling information from obtained place data as behavior data; and
calculating a fee of the behavior data.

18. A behavior data fee collection method using a computer, comprising:
registering facility data;
calculating a registration fee when the data are registered; and
generating data in which a paired series of at least place information and information about the place, provided to a user are described according to a prescribed specification, using registered facility data.

19. A behavior data fee collection method using a computer, comprising:
registering facility data;
generating data in which a paired series of at least place information and information about the place, provided to a user are described according to a prescribed specification, using registered facility data;
obtaining information about use of data when the data are generated; and
charging a fee against each facility at the time.

20. A behavior data fee collection method using a computer, comprising:
registering facility data;
generating data in which a paired series of at least place information and information about the place, provided to a user are described according to a prescribed specification, using registered facility data;
obtaining information about use of data when the data are downloaded, when use of the data is started, when each facility is reported in a process of the data or when guidance or advertisement on each facility is presented to a user in a process of the data; and
charging a fee against each facility at the time.

21. A behavior data fee collection method using a computer, comprising:
obtaining a location or route of a user;
providing information depending on the obtained location and route; and
charging when providing the information.

22. A behavior data fee collection method using a computer, comprising:
registering facility data;
generating data in which a paired series of at least place information and information about the place, provided to a user are described according to a prescribed specification, using registered facility data;
obtaining a location and route of a user;
judging relationship between the data and an actual location or route of a user;
obtaining information about use of data when the data related to a location or route are downloaded, when use of thee data is started or when each facility is reported in a process of the data; and
charging a fee against each facility at the time.

23. A behavior data fee collection method using a computer, comprising:
registering facility data;
obtaining travel data of a user;
judging whether location data included in the facility data match actual travel data of a user;
generating behavior data of a user based on a judgment result; and
calculating a fee of the behavior data.

24. A behavior data fee collection method using a computer, comprising:
registering facility data;
obtaining facility utilization data of a user;
judging whether the facility data match the facility utilization data of a user;
generating behavior data of a user based on a judgment result; and
calculating a fee of the behavior data.

25. A behavior data fee collection method using a computer, comprising:
obtaining behavior data about a series of human behavior; and
detecting a combination of a plurality of pieces of behavior frequently made from obtained behavior data and providing information about or advertising the same behavior combination when a user takes one of the plurality of pieces of behavior.

26. A behavior data fee collection method using a computer, comprising:
obtaining behavior data about a series of human behavior; and
categorizing obtained behavior data for each user attribute and proposing a destination suitable for an attribute when requested by a user with the attribute.

27. A storage medium on which is recorded a program for enabling a computer to implement a behavior data fee collection system using a computer, comprising:
obtaining behavior data about a series of human behavior;
recording and storing obtained behavior data; and
selling recorded and stored behavior data.

28. A storage medium on which is recorded a program for enabling a computer to implement a behavior data fee collection system using a computer, comprising:
obtaining behavior data about a series of human behavior;
recording and storing obtained individual behavior data;
analyzing recorded and stored behavior data and generating statistically processed mass behavior data; and
selling generated mass behavior data.

29. A storage medium on which is recorded a program for enabling a computer to implement a behavior data fee collection system using a computer, comprising:
processing data in which a paired series of at least place information and information about the place, provided to a user are described according to a prescribed specification; and
collecting a fee from a facility included in the place information described in the data.

30. A storage medium on which is recorded a program for enabling a computer to implement a behavior data fee collection system using a computer, comprising:
processing data in which a paired series of at least place information and information about the place, provided to a user are described according to a prescribed specification;
obtaining place data transmitted from the unit;
totaling information from obtained place data as behavior data; and
calculating a fee of the behavior data.

31. A storage medium on which is recorded a program for enabling a computer to implement a behavior data fee collection system using a computer, comprising:
registering facility data;
calculating a registration fee when the data are registered; and
generating data in which a paired series of at least place information and information about the place, provided to a user are described according to a prescribed specification, using registered facility data.

32. A storage medium on which is recorded a program for enabling a computer to implement a behavior data fee collection system using a computer, comprising:
registering facility data;
generating data in which a paired series of at least place information and information about the place, provided to a user are described according to a prescribed specification, using registered facility data;
obtaining information about use of data when the data are generated; and
charging a fee against each facility at the time.

33. A storage medium on which is recorded a program for enabling a computer to implement a behavior data fee collection system using a computer, comprising:
registering facility data;
generating data in which a paired series of at least place information and information about the place, provided to a user are described according to a prescribed specification, using registered facility data;
obtaining information about use of data when the data are downloaded, when use of the data is started, when each facility is reported in a process of the data or when guidance or advertisement on each facility is presented to a user in a process of the data; and
charging a fee against each facility at the time.

34. A storage medium on which is recorded a program for enabling a computer to implement a behavior data fee collection system using a computer, comprising:
obtaining a location or route of a user;
providing information depending on the obtained location and route; and
charging when providing the information.

35. A storage medium on which is recorded a program for enabling a computer to implement a behavior data fee collection system using a computer, comprising:
registering facility data;
generating data in which a paired series of at least place information and information about the place, provided to a user are described according to a prescribed specification, using registered facility data;
obtaining a location and route of a user;
judging relationship between the data and an actual location or route of a user;
obtaining information about use of data when the data related to a location or route are downloaded, when use of thee data is started or when each facility is reported in a process of the data; and
charging a fee against each facility at the time.

36. A storage medium on which is recorded a program for enabling a computer to implement a behavior data fee collection system using a computer, comprising:
registering facility data;
obtaining travel data of a user;
judging whether location data included in the facility data match actual travel data of a user;
generating behavior data of a user based on a judgment result; and
calculating a fee of the behavior data.

37. A storage medium on which is recorded a program for enabling a computer to implement a behavior data fee collection system using a computer, comprising:
registering facility data;
obtaining facility utilization data of a user;
judging whether the facility data match the facility utilization data of a user;
generating behavior data of a user based on a judgment result; and
calculating a fee of the behavior data.

38. A storage medium on which is recorded a program for enabling a computer to implement a behavior data fee collection system using a computer, comprising:
obtaining behavior data about a series of human behavior; and
detecting a combination of a plurality of pieces of behavior frequently made from obtained behavior data and providing information about or advertising the same behavior combination when a user takes one of the plurality of pieces of behavior.

39. A storage medium on which is recorded a program for enabling a computer to implement a behavior data fee collection system using a computer, comprising:
obtaining behavior data about a series of human behavior; and
categorizing obtained behavior data for each user attribute and proposing a destination suitable for an attribute when requested by a user with the attribute.

40. A behavior data fee collection system using a computer, comprising:
acquisition means for obtaining behavior data about a series of human behavior;
storage means for recording and storing obtained behavior data; and
sale means for selling recorded and stored behavior data.
